(19) United States
(12) Patent Application Publication
(10) Pub. No.: US 2015/0270712 A1
(43) Pub. Date: Sep. 24, 2015

(54) CONTROLLING APPARATUS, POWER CONVERTING APPARATUS AND CONTROLLING SYSTEM

(71) Applicant: KABUSHIKI KAISHA TOSHIBA, Minato-ku (JP)

(72) Inventors: Fumiaki KANAYAMA, Kawasaki (JP); Yuusuke KOUNO, Tachikawa (JP); Yasuyuki NISHIBAYASHI, Kawasaki (JP); Yoichi MORISHIMA, Sumida (JP)

(73) Assignee: KABUSHIKI KAISHA TOSHIBA, Minato-ku (JP)

(21) Appl. No.: 14/658,728

(22) Filed: Mar. 16, 2015

(30) Foreign Application Priority Data
Mar. 18, 2014 (JP) 2014-055550

(51) Int. Cl. H02J 3/00; H02M 7/44

(52) U.S. Cl. CPC H02J 3/005; H02M 7/44

(57) ABSTRACT

According to one embodiment, a controlling apparatus comprises an acquiring unit that acquires a power value of a power line, the power line transmitting power between a first grid and a second grid, the first grid including a first power generating apparatus and a power converting apparatus that outputs an alternating-current power based on a power generated by the first power generating apparatus, the second grid including a second power generating apparatus. The controlling apparatus comprises a controlling unit that controls the alternating-current power to be output by the power converting apparatus such that the power value does not fall within a dead band.

### CROSS-REFERENCE TO RELATED APPLICATIONS

This application is based upon and claims the benefit of priority from Japanese Patent Application No. 2014-055550, filed Mar. 18, 2014; the entire contents of which are incorporated herein by reference.

### FIELD

Embodiments described herein relate generally to a controlling apparatus, a power converting apparatus and a controlling system.

### BACKGROUND

Dispersion type power sources in which solar power generating apparatuses or storage batteries are connected with a power system are utilized. These dispersion type power sources, which are interconnected with the power system through power converting apparatuses, need to include an isolated operation detection feature for detecting a parallel-off from the power system and a power outage.

Here, the isolated operation is described. It is assumed here that a local grid is connected with a power system. When a breaker provided on a power line is opened by a power outage in the power system or the like in the case where a power generating apparatus or a power storing apparatus during discharge is not present in the local grid, a local power line to transmit power between the local grid and the breaker becomes in a non-voltage state. However, when the breaker is opened in a state in which a power generating apparatus, a power storing apparatus during discharge or the like is outputting power to the power system through a power converting apparatus, the local power line remains in a charged state.

Thus, the state in which electricity flows to the local power line even when the local grid is paralleled off from the power system is called the isolated operation. The isolated operation can cause an electric shock of a restoration worker, a failure of equipment, and further a fire breakout, for example, and therefore, it is said to be undesirable from a standpoint of safety. Hence, in the power converting apparatus interconnected with the grid, it is required to implement an isolated operation detection feature for instantly detecting the isolated operation, and a feature for stopping the operation of the power converting apparatus, performing the parallel-off of the local grid from the power system, or the like, when the isolated operation is detected.

The technique for the isolated operation detection is basically classified into a passive scheme and an active scheme. In the passive scheme, the power converting apparatus constantly monitors the voltage, the frequency or the like that can be read from an attached sensor, grasps a rapid fluctuation in the voltage, the frequency or the like that occurs at the time of the parallel-off from the power system, and thereby, detects the isolated operation. For example, suppose a configuration in which the output of a power generating apparatus is connected with one terminal of a breaker through a first power converting apparatus by a local power line, the output of a power storing apparatus is joined to the local power line through a second power converting apparatus, and the other terminal of the breaker is connected with a power system by a power line. In this configuration, the direct-current power generated in the power generating apparatus is converted into alternating-current power in the first power converting apparatus, and then, reversely flows to the power system. The direct-current power discharged in the power storing apparatus is converted into alternating-current power in the second power converting apparatus, and then, reversely flows to the power system. In such a configuration, when the breaker is opened, for example, due to the occurrence of a power outage in the power system, the destination of the power, which has reversely flowed to the power system until then, is lost, so that a disorder such as a rapid increase in the voltage or the frequency occurs on the local power line.

The first power converting apparatus and the second power converting apparatus constantly monitor, with attached sensors, the electricity information such as the voltage and frequency of the local power line, can promptly detect the voltage fluctuation associated with the open of the breaker, and judge the isolated operation from this voltage fluctuation. As the information for the judgment criterion of the isolated operation, the frequency, the higher harmonic wave or the like is used other than the voltage.

For example, suppose that a load joined to the local power line is further present in the local grid. Here, the load is an apparatus that performs power consumption, from a viewpoint of the local grid, and for example, is an electric motor, an electric lamp, or a storage battery during charge. In the case where the sum total of the active power output by the power generating apparatus, the power storing apparatus and the like and the sum total of the active power consumed by the load are extremely different, a disorder such as an increase or decrease in the voltage of the local power line occurs along with the open of the breaker. Therefore, it is possible to detect the isolated operation by the same passive scheme as the above.

In the case where the reactive power output by the power converting apparatus is low compared to the active power, and the supply and consumption of the active power in the local grid are roughly equal, a rapid fluctuation in the voltage does not occur even when the breaker is opened. However, since the local power line is paralleled off from the grid, the frequencies to be output by the first power converting apparatus and the second power converting apparatus deviate from the grid frequency. This is because, in association with the occurrence of the parallel-off, the voltage waveform to which a PLL (Phase Locked Loop) included in the power converting apparatus refers switches from the waveform of the grid voltage to the output of the power converting apparatus itself, resulting in the instability of the frequency. When the reactive power to be output by the power converting apparatus is zero, the stabilization point for the frequency of the local power line is the resonance frequency of the load. Therefore, in the case where the resonance frequency is different from the grid frequency, the frequency that can be measured in the local power line shifts toward the resonance frequency in association with the parallel-off. When the reactive power to be output by the power converting apparatus is not zero, the stabilization point is a frequency different from the resonance frequency of the load. In any case, the frequency shifts from the grid frequency toward the stabilization point. Therefore, the first power converting apparatus and the second power converting apparatus sense the frequency from the local power line, and thereby can detect the isolated operation.

Meanwhile, responding to a problem in that the isolated operation detection by the passive scheme is difficult in a dead band at which the transfer of the active power and the reactive power is zero, there has been developed a detection technique called the active scheme, such as a frequency shift, a reactive power fluctuation and a slip-mode frequency shift. In the active scheme, for example, the output targets of the active power, reactive power and others are varied by the control of the power converting apparatus, or the voltage, frequency or others of the local power line is constantly varied by using an external apparatus. Thereby, the fluctuations in the voltage, frequency, higher harmonic wave and others at the time of the parallel-off are more emphasized, and, based on these detected values, the judgment of the isolated operation is more accurately performed.

### BRIEF DESCRIPTION OF THE DRAWINGS

FIG. 1 is a diagram showing the configuration of a power converting system S1 according to the first embodiment.

FIG. 2 is a schematic equivalent circuit of the power converting system S1.

FIG. 3 is a diagram showing the configuration of the wattmeter 15 according to the first embodiment.

FIG. 4 is a diagram showing the configuration of the power converting apparatus 11 according to the first embodiment.

FIG. 5 is a flowchart showing the first process according to the first embodiment.

FIG. 6 is a flowchart of a process to be performed by the power converting apparatus 11.

FIG. 7 is a flowchart showing a modification.

FIG. 8 is a flowchart showing the second process in the first embodiment.

FIG. 9 is a diagram for explaining a control based on the evaluation function.

FIG. 10 is a diagram showing the configuration of a power converting system S2 according to the second embodiment.

FIG. 11 is a diagram showing the configuration of the wattmeter 15b according to the second embodiment.

FIG. 12 is a diagram showing the configuration of the EMS server 17 according to the second embodiment.

FIG. 13 is a diagram showing the configuration of the power converting apparatus 11b according to the second embodiment.

FIG. 14 shows the configuration for explaining a virtual wattmeter.

FIG. 15 is a diagram for explaining a calculation method of the measured value of the virtual wattmeter 153.

FIG. 16 is an installation example of wattmeter.

FIG. 17 is a diagram showing the configuration of a power converting system S4 according to the fourth embodiment.

FIG. 18 is an equivalent circuit diagram of FIG. 17 in the case of a single phase.

FIG. 19 is an equivalent circuit diagram of the circuit in FIG. 18 from a viewpoint of the primary side (the local grid side).

FIG. 20 is a diagram showing the configuration of a power converting system S5 according to the fifth embodiment.

FIG. 21 is a diagram showing the configuration of a power converting system S6 according to the sixth embodiment.

FIG. 22 is a diagram showing the configuration of the EMS server 17f according to the sixth embodiment.

FIG. 23 is a flowchart showing a compensation process example according to the sixth embodiment.

FIG. 24 is a diagram showing the configuration of a power converting system S7 according to the seventh embodiment.

FIG. 25 is a diagram showing the configuration of the EMS server 17j according to the seventh embodiment.

FIG. 26 is a diagram showing the configuration of the power converting apparatus 11-i according to the seventh embodiment.

FIG. 27 is a diagram showing the configuration of a power converting system S8 according to the eighth embodiment.

FIG. 28 is a diagram showing the configuration of the EMS server 17g according to the eighth embodiment.

FIG. 29 is a diagram showing the configuration of the EMS server 17h according to the eighth embodiment.

FIG. 30 is a first application example of the configuration of a power converting system according to the embodiments.

FIG. 31 is a second application example of a power converting system according to the embodiments.

FIG. 32 is a third application example of a power converting system according to the embodiments.

### DETAILED DESCRIPTION

According to one embodiment, a controlling apparatus comprises an acquiring unit that acquires a power value of a power line, the power line transmitting power between a first grid and a second grid, the first grid including a first power generating apparatus and a power converting apparatus that outputs an alternating-current power based on a power generated by the first power generating apparatus, the second grid including a second power generating apparatus. The controlling apparatus comprises a controlling unit that controls the alternating-current power to be output by the power converting apparatus such that the power value does not fall within a dead band.

Hereinafter, embodiments of the present invention will be described with reference to the drawings.

In a power converting system according to the embodiments, a first grid including a first power generating apparatus and a power converting apparatus to output alternating-current power based on the power generated by the first power generating apparatus, and a second grid including a second power generating apparatus are connected by a power line. Here, each embodiment will be described below, assuming that the first grid is a local grid as an example and the second grid is a power system as an example.

### First Embodiment

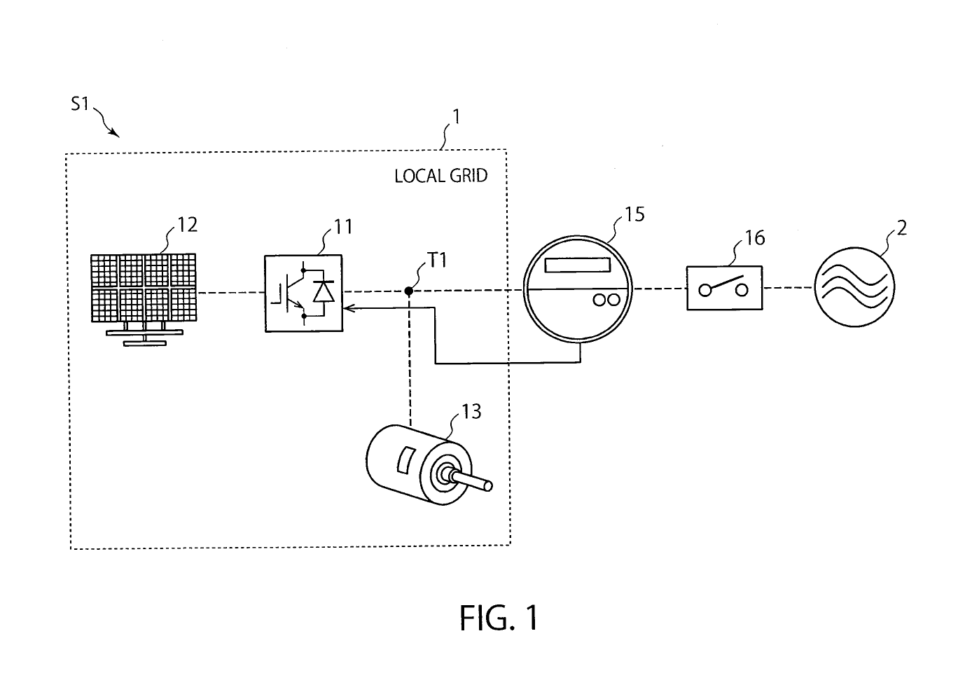

Firstly, a first embodiment will be described. FIG. 1 is a diagram showing the configuration of a power converting system S1 according to the first embodiment.

The power converting system S1 includes a power generating apparatus 12, a power converting apparatus 11 in which an input is connected with an output of the power generating apparatus 12 by a power line and an output is connected with a breaker 16 by a power line, and a load 13 that is connected with the output of the power converting apparatus 11 through a connecting point T1 by a power line. Furthermore, the power converting system S1 includes the breaker 16 in which one terminal is connected with the connecting point T1 by a power line, and a power system 2 that is connected with the other terminal of the breaker 16 by a power line.

Here, these power lines may be also one of the constituent elements of the power converting system S1 or a local grid 1. Here, in the power lines, the number of wires may be different depending on the number of phases and the presence or absence of a ground wire, and multiple types of power lines may be mixed in the single local grid 1.

The power generating apparatus 12, the power converting apparatus 11 and the load 13 are included in the local grid 1. The local grid 1 is interconnected with the power system 2, through the breaker 16.

The power generating apparatus 12 is an apparatus that converts various forms of energy into electric energy. Examples of the power generating apparatus 12 include a solar power generator (PV: Photovoltaic) using light energy, a water power generator or wind power generator using fluid energy such as water flow or wind flow, a thermal power generator to convert chemical energy such as fossil fuel into power, a geothermal power generator using the heat present in nature, a power generator by vibration or tidal power, and others. The power generating apparatus 12 includes a nuclear power generator, although being different in scale. In many cases, the power generating apparatus 12 has a configuration in which a variety of energy forms are temporarily converted into rotary motion and then power is obtained using a synchronous machine, but there is a power generating form that does not depend on kinetic energy, such as a solar power generator. The apparatus may adopt a form having multiple features such as an apparatus that serves as a water heater and a gas fired power generator concurrently. Further, the power generating apparatus 12 includes a storage battery during discharge.

The load 13 is an apparatus that consumes power and that converts electric energy into another energy form. In many cases, the load 13 converts electric energy into thermal energy, directly or indirectly. As representative examples of the load 13, a motor, a light, a heating apparatus, a computer and the like are possible. In a micro grid, a motor is often present as a combination with another apparatus such as an electrical household appliance, an elevator or an escalator, or as a form in which an additional feature is added.

When the load 13 is a motor, power is converted into dynamic force or kinetic energy, to be consumed. On this occasion, in some cases, the dynamic force generated by the motor is directly utilized as driving force. Alternatively, in some cases, the conversion of the motion speed or direction, the conversion or linear-motion conversion for the shift or rotation of the rotary axis, the divergence or combination of kinetic energy, or the like is performed through a dynamic force converting device such as a gear wheel. It is possible that the whole dynamic force system including the motor and the dynamic force transmitting mechanism or dynamic force converting system is regarded as the load of the system.

In practice, members with some impedance, including the inductance and capacitance that do not involve energy consumption, are extensively included in the load 13. This includes an impedance of a magnitude that is negligible in some cases, such as a very small electric resistance, inductance and earth capacitance of a wire, as well as members with a relatively large impedance such as a pole-mounted transformer. Further, the load 13 includes a storage battery during charge.

In the parallel-off of the local grid 1 from the power system 2, the breaker 16 puts the one terminal and the other terminal into a non-conduction state. When the local grid 1 is interconnected with the power system 2, the breaker 16 puts the one terminal and the other terminal into a conduction state.

The power converting apparatus 11, which has a communication feature, performs the power conversion while communicating with a wattmeter 15 that has a communication feature similarly. Concretely, the power converting apparatus 11 converts the direct-current power input from the power generating apparatus 12, into alternating-current power. Some of the alternating-current power after the conversion is consumed by the load 13, and the power converting apparatus 11 supplies the residual alternating-current power to the power system 2 through the breaker 16.

The power converting apparatus 11 is, for example, an inverter, a converter, a voltage inverter (transformer), or the like. The power converting apparatus 11 means an apparatus that executes the conversion from direct current into alternating current, or the conversion of voltage, current, frequency, the number of phases or the like while there is no or little power consumption by the apparatus itself. The inverter, which is typically an apparatus to convert a direct-current power source into an alternating-current power source, includes also an inverter that has a feature for converting an alternating-current power source into a direct-current power source by switching the operation mode.

Also, an apparatus such as a breaker or a power router, which performs the break or alteration of a power transmitting path, can be seen as the power converting apparatus in a broad sense. In some cases, a plurality of power converting apparatuses is present in a local grid. These power converting apparatuses can control the outputs, under the instruction by a controller such as an EMS (Energy Management System) server, or by the coordinate operation among the power converting apparatuses. Not only the power converting apparatuses but also a variety of apparatuses such as the power generating apparatus can join in the coordinate operation.

The wattmeter 15 measures the power value at a predetermined position on the power line that connects the connecting point T1 and the breaker 16. Concretely, the power value is the measured value of the active power and the measured value of the reactive power. The wattmeter 15, which includes, for example, an ammeter and a voltmeter, multiplies a measured current value and voltage value, and thereby, obtains the measured value of the active power and the measured value of the reactive power.

The wattmeter 15 sends the obtained measured value of the active power and the obtained measured value of the reactive power, to the power converting apparatus 11 by communication. This communication may be a wireless communication, or may be a wire communication.

Here, the power converting system S1 or the local grid 1 can include all kinds of sensors. For example, the sensors are a smart meter, a voltmeter, an ammeter, a temperature sensor and the like. In some cases, the sensors are built into an apparatus such as the power converting apparatus 11, and in some cases, they include a communication feature and operate as external sensors installed in the exterior of the power converting apparatus 11. Further, the sensors may be utilized for the control of the whole of the system, by configuring a sensor network.

Here, in the local grid 1, there may be an EMS server such as a HEMS (Home Energy management System). Further, the positional relation between the breaker 16 and the wattmeter 15 may be reversed.

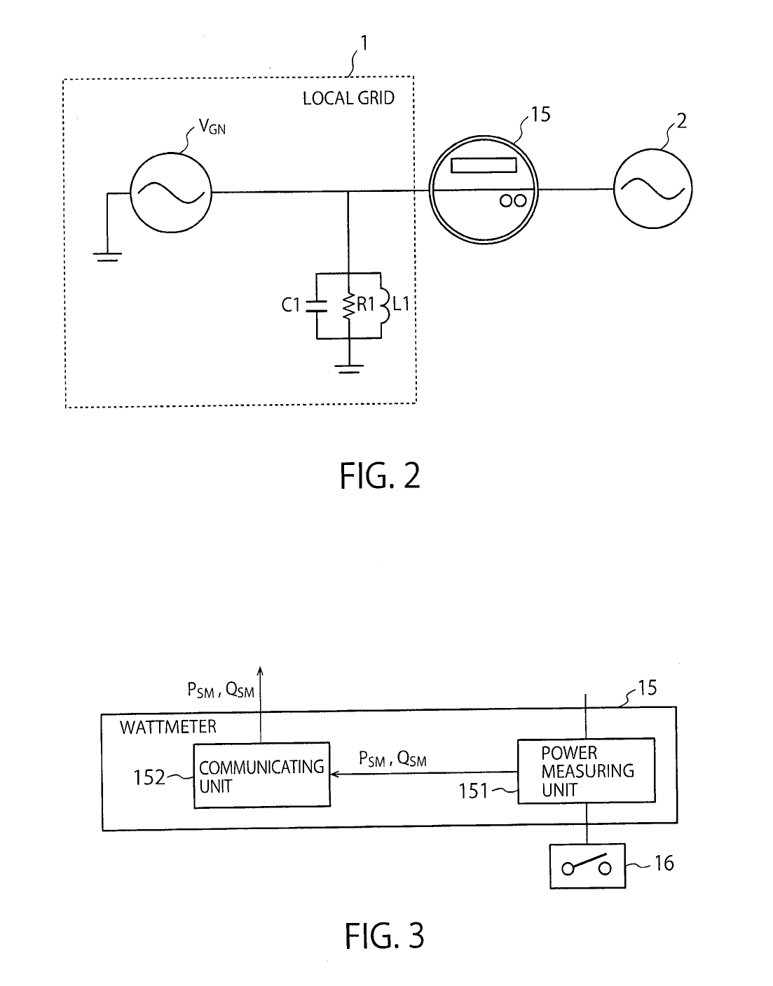

FIG. 2 is a schematic equivalent circuit of the power converting system S1. The equivalent circuit in FIG. 2 includes a power source V_{GN} in which one terminal is connected with the ground, a condenser C1 in which one terminal is connected with an output of the power source V_{GN} and the other terminal is connected with the ground, a resistance R1 that is connected in parallel with the condenser C1, an inductor L1 that is connected in parallel with the resistance R1, and the power system 2 that is connected with an output of the power source V_{GN}. When the active power “P” and reactive power “Q” to be output by the power source V_{GN} respectively balance with the active power “P” and reactive power “Q” to be consumed by the condenser C1, the resistance R1 and the inductor L1, the active power “P” and reactive power “Q” in the wattmeter 15 are both 0. Here, the state in which the transfer of the active power “P” and reactive power “Q” is zero is referred to as a dead band.

When the condition of the dead band is satisfied at the position of the wattmeter 15 in this way, it is difficult for the power converting apparatus 11 to properly detect the isolated operation, and it is impossible to judge whether the state of the local grid 1 falls under the dead band, only from the information to be obtained from the sensors included in the power converting apparatus 11. Meanwhile, the wattmeter 15 can measure the power to be transferred between the local grid 1 and the power system 2. At the dead band, the power amount to be measured is 0 for both of the active power “P” and the reactive power “Q”, and therefore, it is possible for the wattmeter 15 to detect the dead band.

Also, when all the apparatuses in the local grid 1 have stopped their operations, or when the breaker 16 has performed the break between the local grid 1 and the power system 2, the active power “P” and reactive power “Q” to be measured by the wattmeter 15 are both 0. However, this state is not called the dead band. When it is possible to acquire the state information about the breaker 16 or the information about whether a working apparatus is present in the local grid 1, the power converting apparatus 11, the wattmeter 15 and the EMS server perform the judgment for the dead band in the light of such information.

Hence, in the power converting system S1 according to the embodiment, the wattmeter 15 measures the active power and the reactive power, and, by communication, sends the measured value of the active power and the measured value of the reactive power obtained by the measurement, to the power converting apparatus 11. The power converting apparatus 11, after receiving these values, judges whether the combination of the measured value of the active power and the measured value of the reactive power is within a set range that is previously set, based on the measured value of the active power and the measured value of the reactive power. Then, in the case of being within the set range, the power converting apparatus 11 controls the alternating-current power to be output such that it avoids the dead band, or starts an isolated operation detection with an active scheme. The active scheme is used only when the state of the local grid 1 is close to the dead band, and thereby, it is possible to prevent an unnecessary disturbance from being given to the power system 2 in the normal period.

### (Configuration)

FIG. 3 is a diagram showing the configuration of the wattmeter 15 according to the first embodiment. The wattmeter 15 includes a power measuring unit 151 and a communicating unit 152 that is electrically connected with the power measuring unit 151.

The power measuring unit 151 measures the power value at a predetermined position on the power line that transmits power between the local grid 1 and the power system 2. Concretely, for example, the power measuring unit 151 measures the power value at a predetermined position on the power line that connects the connecting point T1 and the breaker 16. Concretely, this power value is the active power value and the reactive power value. The power measuring unit 151 outputs the measured value “P_{SM}” of the active power and the measured value “Q_{SM}” of the reactive power obtained by the measurement, to the communicating unit 152.

The communicating unit 152 sends the measured value “P_{SM}” of the active power and the measured value “Q_{SM}” of the reactive power input from the power measuring unit 151, to the power converting apparatus 11. This sending may be by a wireless communication or may be by a wire communication.

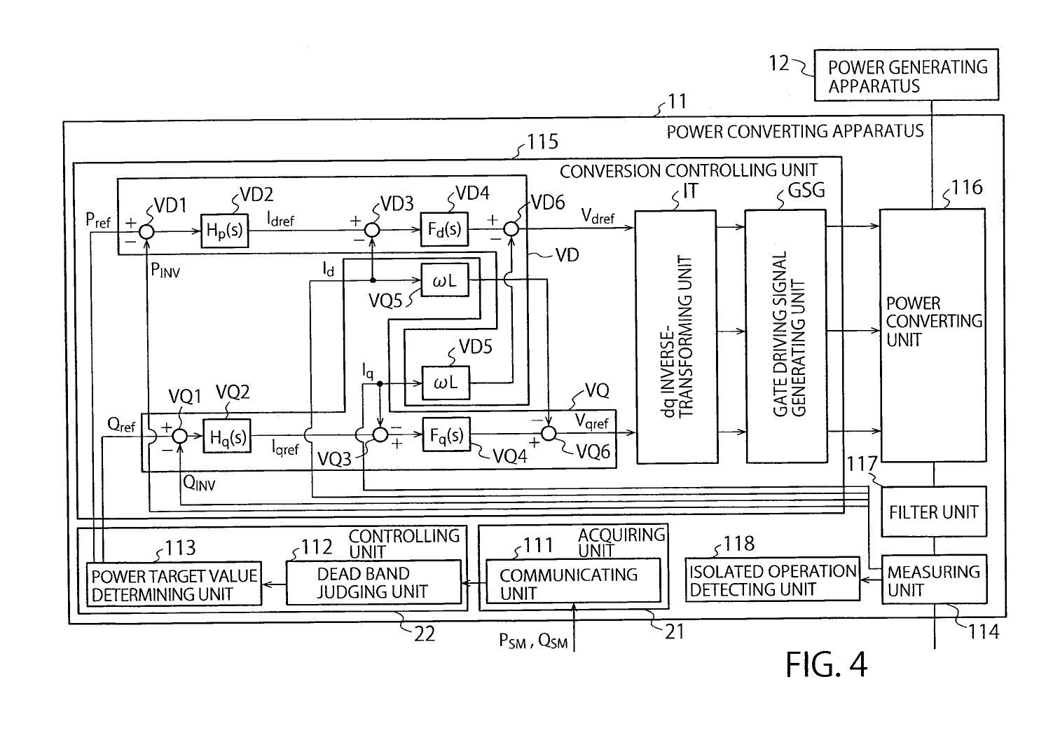

FIG. 4 is a diagram showing the configuration of the power converting apparatus 11 according to the first embodiment. The power converting apparatus 11 includes an acquiring unit 21 and a controlling unit 22 that is electrically connected with the acquiring unit 21. Furthermore, the power converting apparatus 11 includes a measuring unit 114, a conversion controlling unit 115 that is electrically connected with the controlling unit 22 and the measuring unit 114, a power converting unit 116 that is electrically connected with the conversion controlling unit 115, a filter unit 117 that is connected with the power converting unit 116 by a power line, and an isolated operation detecting unit 118 that is electrically connected with the measuring unit 114.

The acquiring unit 21 acquires the power value of a power line to transmit power between a first grid including a first power generating apparatus and a power converting apparatus to output alternating-current power based on the power generated by the first power generating apparatus, and a second grid including a second power generating apparatus. Here, in the embodiment, the first grid is the local grid 1 as an example, and the second grid is the power system 2 as an example. The acquiring unit 21 includes a communicating unit 111.

The communicating unit 111 receives the measured value “P_{SM}” of the active power and the measured value “Q_{SM}” of the reactive power sent from the wattmeter 15, and outputs the measured value “P_{SM}” of the active power and the measured value “Q_{SM}” of the reactive power that have been received, to a dead band judging unit 112.

The controlling unit 22 controls the alternating-current power to be output by the power converting apparatus 11 such that the above power values do not fall within the dead band, based on the power values acquired by the acquiring unit 21. Here, the controlling unit 22 includes the dead band judging unit 112 that is electrically connected with the communicating unit 111, and a power target value determining unit 113 that is electrically connected with the dead band judging unit 112.

The dead band judging unit 112 judges whether the combination of the measured value “P_{SM}” of the active power and the measured value “Q_{SM}” of the reactive power received by the communicating unit 111 is within a set range that is previously set. This set range is a range containing the dead band, at which the active power value is 0 and the reactive power value is 0.

In the case where the dead band judging unit 112 makes the judgment of being within the set range, the power target value determining unit 113 determines a target value of the alternating-current power to be output by the power converting apparatus 11, which is used when the power converting apparatus 11 controls the output power. Concretely, the power target value determining unit 113 alters at least one of the target value of the active power and the target value of the reactive power for the alternating-current power to be output by the power converting apparatus 11. The power target value determining unit 113 outputs, to the conversion controlling unit 115, the target value of the active power and the target value of the reactive power after the alteration is performed.

The measuring unit 114 measures the alternating-current power to be output through the filter unit 117 by the power converting unit 116. For more detail, the measuring unit 114 measures the active power value “P_{INV}” and reactive power value “Q_{INV}” of the power output from the filter unit 117, and outputs the active power value “P_{INV}” and reactive power value “Q_{INV}” obtained by the measurement, to the conversion controlling unit 115.

The measuring unit 114 measures the alternating current value to be output through the filter unit 117 by power converting unit 116. For more detail, the measuring unit 114 measures the alternating current output from the filter unit 117. Then, the measuring unit 114 performs the dq conversion of the alternating current, and outputs the d current component “I_{d}” and q current component “I_{q}” obtained by the alteration, to the conversion controlling unit 115.

Further, the measuring unit 114 measures the voltage value of the voltage output through the filter unit 117 by power converting unit 116, and outputs the measured voltage value to the isolated operation detecting unit 118.

The power converting unit 116 converts the input direct-current power into alternating-current power, and outputs the alternating-current power after the conversion, to the power system 2 through the filter unit 117.

The filter unit 117 removes high-frequency noise that is contained in the alternating-current power output from the power converting unit 32. For example, the filter unit 117 applies a predetermined low-pass filter to the alternating-current power output from the power converting unit 116, and outputs the alternating-current power after the low-pass filter, to the power system 2 through the breaker 16. As an example, the filter unit 117 includes an inductor in which one terminal is connected in series with an output of the power converting unit 116 and the other terminal is connected with one terminal of the breaker 16, and a condenser in which one terminal is connected with one phase of the outputs of the power converting unit 116 and the other terminal is connected with another phase of the outputs.

The isolated operation detecting unit 118 detects the isolated operation, based on the voltage value measured by the measuring unit 114. Here, the isolated operation detecting unit 118 may detect whether to be the isolated operation, based on the frequency or higher harmonic wave of the alternating-current power that is measured by the measuring unit 114.

The conversion controlling unit 115 controls the power converting unit 116, based on the target value of the alternating-current power determined by the power target value determining unit 113, and the alternating-current power value measured by the measuring unit 114. Concretely, for example, a gate driving signal corresponding to the power target value is generated, and thereby, semiconductor elements of the power converting unit 116 are driven. Further, the conversion controlling unit 115 controls the power converting unit 116, also based on the alternating current measured by the measuring unit 114.

Here, the conversion controlling unit 115 may have such a configuration to boost the direct-current voltage as the input in a chopper circuit or the like, and to change the power conversion efficiency.

Here, the conversion controlling unit 115 includes a first voltage target value generating unit VD and a second voltage target value generating unit VQ. Furthermore, the conversion controlling unit 115 includes a dq inverse-transforming unit IT that is electrically connected with an output of the first voltage target value generating unit VD and an output of the second voltage target value generating unit VQ, and a gate driving signal generating unit GSG that is electrically connected with the dq inverse-transforming unit IT by three wires.

The first voltage target value generating unit VD generates a voltage target value “V_{dref}” of the d component, based on an active power target value “P_{ref}” input from the power target value determining unit 113, and the active power value “P_{INV}”, d current component “I_{d}” and q current component “I_{q}” input from the measuring unit 114. Here, the first voltage target value generating unit VD includes a subtracting unit VD1, a transfer function multiplying unit VD2, a subtracting unit VD3, a transfer function multiplying unit VD4, a multiplying unit VD5 and a subtracting unit VD6.

The subtracting unit VD1 subtracts the active power value “P_{INV}”, from the active power target value “P_{ref}” input from the power target value determining unit 113, and outputs the value after the subtraction, to the transfer function multiplying unit VD2.

The transfer function multiplying unit VD2 multiplies the input value by a predetermined transfer function “Hₚ(s)”, and outputs the d component “I_{dref}” of the obtained current target value to the subtracting unit VD3. Here, “Hₚ(s)=Kₕₚₚ+Kₕₚₚ/s” holds. Here, “Kₕₚₚ” is a proportionality coefficient, and “Kₕₚᵢ” is an integration coefficient.

The subtracting unit VD3 subtracts the d current component “I_{d}” input from the measuring unit 114, from the d component “I_{dref}” of the current target value, and outputs the value obtained by the subtraction, to the transfer function multiplying unit VD4.

The transfer function multiplying unit VD4 multiplies the value input from the subtracting unit VD3, by a predetermined transfer function “F_{d}(s)”, and outputs the obtained value to the subtracting unit VD6. Here, “F_{d}(s)=K_{fdp}+K_{fdi} s” holds. Here, “K_{fdp}” is a proportionality coefficient, and “K_{fdi}” is an integration coefficient. Further, this obtained value is the d component of the voltage target value when assuming that the filter unit 117 has no inductor.

The multiplying unit VD5 multiplies the q component “I_{q}” of the current input from the measuring unit 114, by “ωL”, and outputs the value obtained by the multiplication, to the subtracting unit VD6. Here, “ω” is an angular frequency, and “L” is the inductance of the inductor included in the filter unit 117.

The subtracting unit VD6 subtracts the value input from the multiplying unit VD5, from the value input from the transfer function multiplying unit VD4. This is because the voltage drop in the inductor of the filter unit 117 is considered. Then, the subtracting unit VD6 outputs the value obtained by the subtraction to the dq inverse-transforming unit IT, as the d component “V_{dref}” of the voltage target value. Thereby, it is possible to increase the d component of the voltage target value, by the amount of the voltage drop in the inductor of the filter unit 117.

Similarly, the second voltage target value generating unit VQ generates a voltage target value “V_{qref}” of the q component, based on a reactive power target value “Q_{ref}” input from the power target value determining unit 113, and the reactive power value “Q_{INV}”, d current component “I_{d}” and q current component “I_{q}” input from the measuring unit 114. Here, the second voltage target value generating unit VQ includes a subtracting unit VQ1, a transfer function multiplying unit VQ2, a subtracting unit VQ3, a transfer function multiplying unit VQ4, a multiplying unit VQ5 and a subtracting unit VQ6.

The subtracting unit VQ1 subtracts the reactive power value “Q_{INV}”, from the reactive power target value “Q_{ref}” input from the power target value determining unit 113, and outputs the value after the subtraction, to the transfer function multiplying unit VQ2.

The transfer function multiplying unit VQ2 multiplies the input value by a predetermined transfer function “H_{q}(s)”, and outputs the q component “I_{qref}” of the obtained current target value to the subtracting unit VQ3. Here, “H_{q}(s)=K_{hqp}+K_{hqi}/s” holds. Here, “K_{hqp}” is a proportionality coefficient, and “K_{hqi}” is an integration coefficient.

The subtracting unit VQ3 subtracts the q current component “I_{q}” input from the measuring unit 114, from the q component “I_{qref}” of the current target value, and outputs the value obtained by the subtraction, to the transfer function multiplying unit VQ4.

The transfer function multiplying unit VQ4 multiplies the value input from the subtracting unit VQ3, by a predetermined transfer function “F_{q}(s)”, and outputs the obtained value to the subtracting unit VQ6. Here, “F_{q}(s)=K_{fqp} K_{fqi}/s” holds. Here, “K_{fqp}” is a proportionality coefficient, and “K_{fqi}” is an integration coefficient. Further, this obtained value is the q component of the voltage target value when assuming that the filter unit 117 has no inductor.

The multiplying unit VQ5 multiplies the d component “I_{d}” of the current input from the measuring unit 114, by “ωL”, and outputs the value obtained by the multiplication, to the subtracting unit VQ6.

The subtracting unit VQ6 subtracts the value input from the multiplying unit VQ5, from the value input from the transfer function multiplying unit VQ4. This is because the voltage drop in the inductor of the filter unit 117 is considered. Then, the subtracting unit VQ6 outputs the value obtained by the subtraction to the dq inverse-transforming unit IT, as the q component “V_{qref}” of the voltage target value. Thereby, it is possible to increase the q component of the voltage target value, by the amount of the voltage drop in the inductor of the filter unit 117.

The dq inverse-transforming unit IT performs the dq inverse transformation, to the d component “V_{dref}” of the voltage target value input from the first voltage target value generating unit VD and the q component “V_{qref}” of the voltage target value input from the second voltage target value generating unit VQ. Thereby, the target values of the voltages for the three phases are obtained. The dq inverse-transforming unit IT outputs each of the obtained target values of the voltages for the three phases, to the gate driving signal generating unit GSG.

Next, in order to control the respective powers for the three phases, the gate driving signal generating unit GSG generates three gate driving signals, based on the target values of the voltages for the three phases that have been input from the dq inverse-transforming unit IT. The gate driving signal generating unit GSG outputs the three generated gate driving signals to the power converting unit 116. Then, based on each of the three gate driving signals, the power converting unit 116 outputs the power for the corresponding phase.

### (Explanation of Process)

The values of the active power target value “P_{ref}” and reactive power target value “Q_{ref}” at the normal time are, for example, values that are previously fixed at the shipment time, designated values that are received by communication from superordinate equipment such as the EMS server, or another power converting apparatus, target values that are determined for performing the coordinate control with another power converting apparatus, or the like. Meanwhile, the wattmeter 15 measures, in the measuring unit 114, the active power “P_{SM}” and reactive power “Q_{SM}” that come and go on the power line, and the measured values are transmitted to the power converting apparatus 11 by communication.

Based on the measured values received by communication, the dead band judging unit 112 of the power converting apparatus 11 judges whether the output power of the local grid 1 is within the set range. The judgment criterion for the dead band is for example, whether both of “P_{SM}” and “Q_{SM}” are ±1 kW or less, or the like. In the case of being within the set range, the power target value determining unit 113 of the power converting apparatus 11 renews at least one of the active power target value “P_{ref}” and the reactive power target value “Q_{ref}” such that the power output of the local grid 1 does not fall within the dead band, and continues the control.

For example, if, at the normal time, the control is performed at “P_{ref}”=10 kW and “Q_{ref}”=0 kW, a reactive power equivalent to 5% of “P_{ref}” is set as the renewal value of “Q_{ref}”.

By executing such a procedure, even when the power output of the local grid 1 falls within the dead band, the wattmeter 15 and the power converting apparatus 11 can make it away from the dead band, while cooperating by communication. By certainly avoiding the dead band, the isolated operation detecting unit 118 of the power converting apparatus 11 can detect the isolated operation state properly and quickly.

Based on values such as the voltage value and the frequency that can be detected from the sensors of the measuring unit 114 included in the power converting apparatus 11, the isolated operation detecting unit 118 of the power converting apparatus 11 performs, for example at a predetermined time interval, the process of judging whether to be in the isolated operation state, in parallel with or together with the above procedure.

Here, the judgment for the dead band, the alteration of the power target value, and the judgment for the isolated operation need not be always performed by the power converting apparatus 11. It is possible that the wattmeter 15, an EMS server (not shown in the figure) to acquire the measured value of the wattmeter by communication, or a facility in the power system side performs the judgment, and performs the transmission to the power converting apparatus 11 by communication. Further, it is possible that the judgment by the wattmeter 15 or the EMS server is used as a backup mechanism for the judgment by the power converting apparatus 11.

### First Process Example

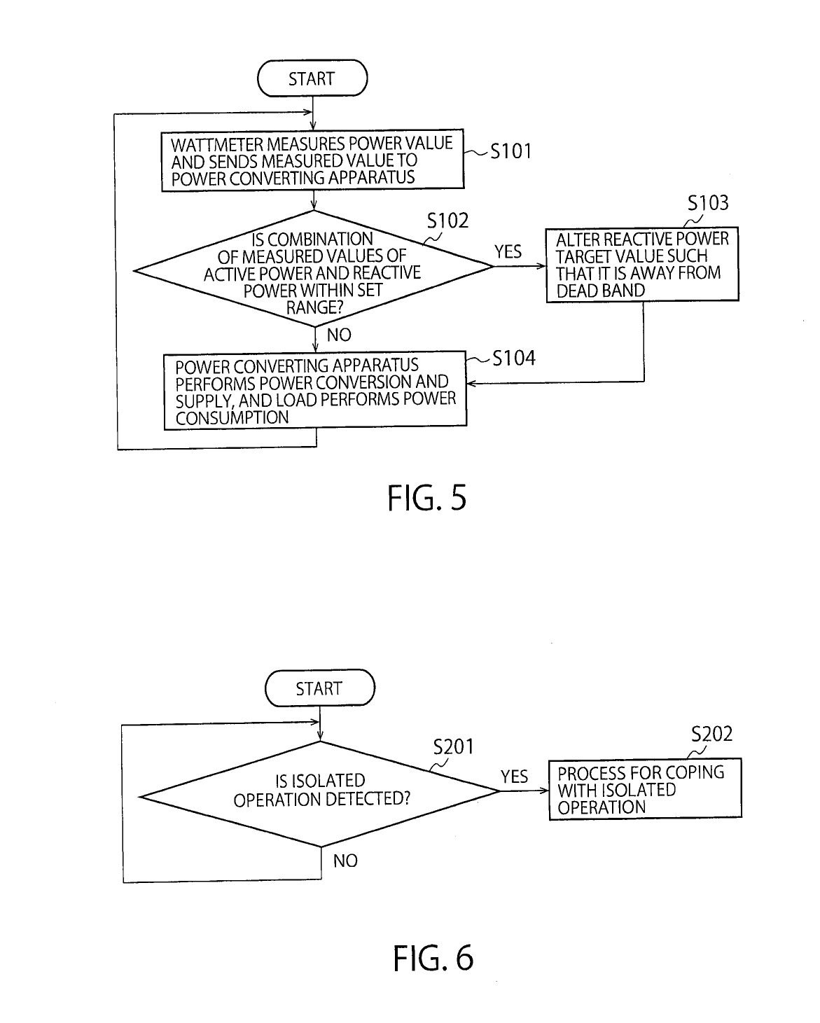

Next, a first process example of the power converting system S1 according to the embodiment will be described using FIG. 5. FIG. 5 is a flowchart showing the first process according to the first embodiment.

(Step S101) The wattmeter 15 measures the active power and the reactive power, and sends, to the power converting apparatus 11, the measured value of the active power and the measured value of the reactive power obtained by the measurement.
(Step S102) The dead band judging unit 112 of the power converting apparatus 11 judges whether the combination of the measured value of the active power and the measured value of the reactive power is within the set range.
(Step S103) In the case of judging that the combination of the measured value of the active power and the measured value of the reactive power is within the set range in step S102, the reactive power target value “Q_{ref}” is altered so as to be away from the dead band. Then, the power converting apparatus 11 proceeds to a process in step S104.
(Step S104) In the case of judging that the combination of the measured value of the active power and the measured value of the reactive power is not within the set range in step S102, the power converting apparatus 11 converts the power and supplies the alternating-current power after the conversion, to the load 13 and the power system 2, and the load 13 consumes some of the alternating-current power.

FIG. 6 is a flowchart of a process to be performed by the power converting apparatus 11. The process in FIG. 6 is performed in parallel with the process in FIG. 5.

(Step S201) First, the isolated operation detecting unit 118 judges whether to be the isolated operation, based on the voltage value measured by the measuring unit 114. In the case of the judgment of being not the isolated operation, the isolated operation detecting unit 118 repeats the judgment at a predetermined time interval.
(Step S202) In the case of judging the isolated operation in step S201, the power converting apparatus 11 executes a process for coping with the isolated operation. For example, the power converting apparatus 11 stops the operation.

Thus, in the first process example, the power converting apparatus avoids the dead band by cooperating with the wattmeter 15, and therefore, can perform the isolated operation detection certainly and quickly. Even when the active scheme is concurrently used, there is an effect of increase in the certainty and the quickness. In addition, when the active scheme is not concurrently used, there is a merit that the isolated operation detection can be performed while the grid disturbance and the mutual interference between power converting apparatuses is prevented.

### (Relay by EMS or Third Party Aggregator, or Variation of Controlling Entities)

Further, as for the communication between the wattmeter 15 and the power converting apparatus 11, another communicating apparatus such as an EMS server and a local controller may intermediate. It is allowable that the EMS server merely just relays the communication between the wattmeter 15 and the power converting apparatus 11. Further, the EMS server may have a feature for judging whether the local grid 1 falls under the dead band condition, by adopting the measured power value sent by the wattmeter 15 as the judgment criterion, and sending a dead band warning or a control target value to the power converting apparatus 11.

Further, a communication message may be sent, through a home gateway or the like, to a server, aggregator or the like in a power company that is installed in the exterior of the local grid 1, and these external facilities may perform the dead band judgment and the control. For convenience sake, these external facilities are also included in the EMS server, here. That is, in the flowchart of FIG. 5, steps S102 and S103 may be executed by any of the power converting apparatus 11, the load 13, the wattmeter 15 and the EMS server. That is, the dead band judging unit 112 and the power target value determining unit 113 may be included in the load 13, the wattmeter 15 or the EMS server, instead of the power converting apparatus 11.

(Exception Process when all Apparatuses in Local Grid 1 have Stopped)

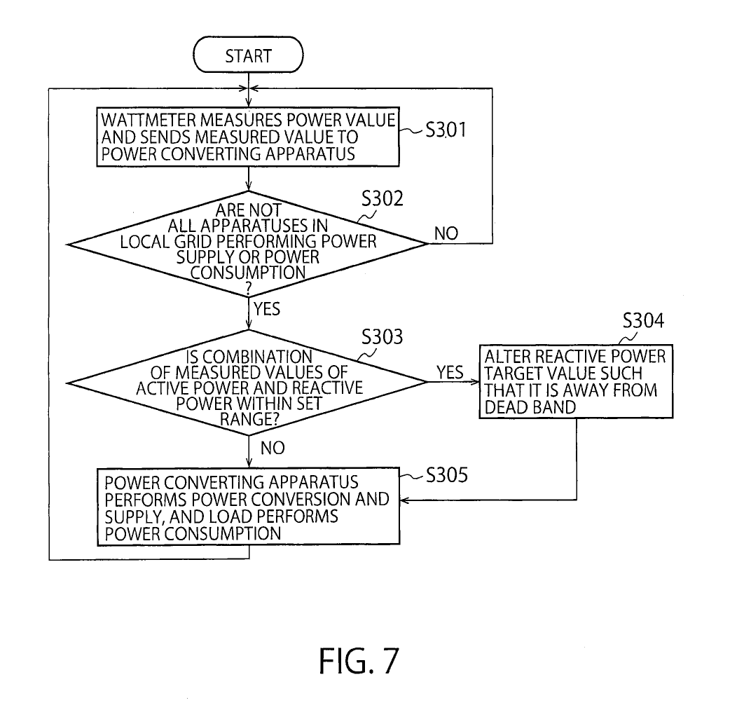

As for steps S102 and S103 in FIG. 5, an exception may be provided. For example, assuming that all apparatuses in the local grid 1 have stopped, the active power value “P_{SM}” and reactive power value “Q_{SM}” to be measured in the wattmeter 15 are both zero, and fall under the dead band on the flowchart in FIG. 5. As an example for excluding such a state from the dead band, the load 13 having a communication feature may provide, by communication, the information that its own apparatus has stopped the power supply or the power consumption, to the power converting apparatus 11 that executes the judgment in step S102. A process flow on this occasion will be described using FIG. 7.

FIG. 7 is a flowchart showing a modification. Step S301 is the same as step S101 in FIG. 5, and steps S304 to S305 are the same as steps S103 to S104 in FIG. 5. Therefore, the explanations are omitted.

(Step S302) The dead band judging unit 112 judges whether all apparatuses in the local grid 1 are not performing the power supply or the power consumption. Concretely, based on the information from the load 13 about whether the power consumption is being performed, the dead band judging unit 112 judges whether the power converting apparatus 11 is not performing the power supply and the load 13 is not performing the power consumption. In the case where all apparatuses in the local grid 1 is not performing the power supply or the power consumption, the power converting system S1 returns the process to step S301.
(Step S303) In the case of judging that at least one apparatus of the apparatuses in the local grid 1 is performing the power supply or the power consumption in step S302, the dead band judging unit 112 judges whether the combination of the measured value of the active power and the measured value of the reactive power is within the set range.

Here, when the wattmeter 15 or the EMS server includes the dead band judging unit 112, the power converting apparatus 11 and the load 13 having a communication feature may send, to the wattmeter 15 or the EMS server, the information that its own apparatus has stopped the power supply or the power consumption.

### Second Process Example

### Start of Active Scheme Triggered by Falling within Set Range

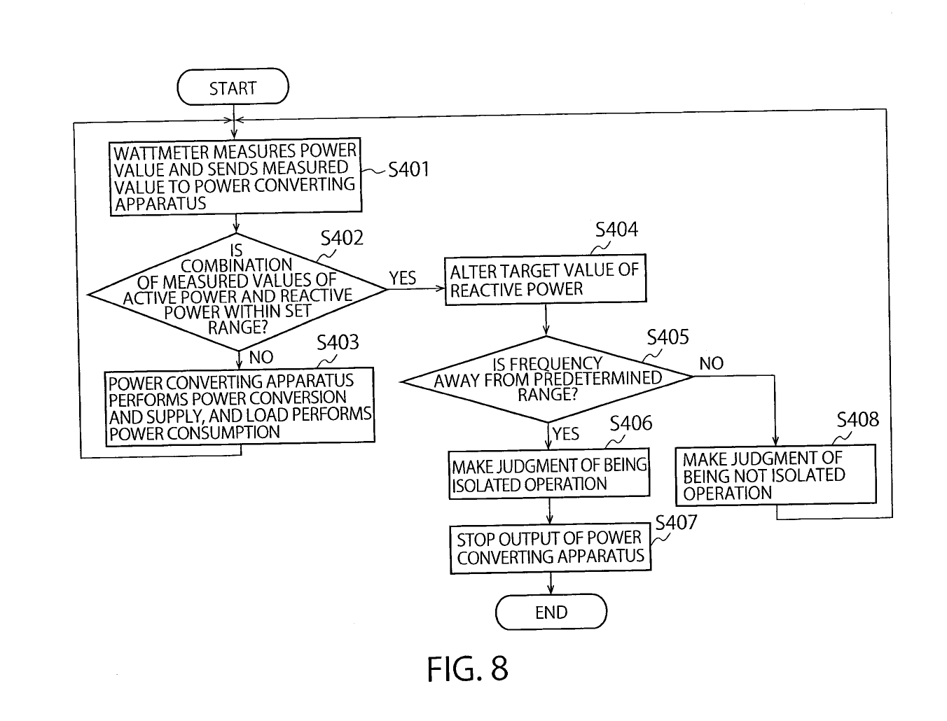

In a second process example, the power converting apparatus 11 starts the isolated operation detection by the active scheme, which is triggered by the falling within the set range. In the second process example, although the isolated operation detecting unit 118 of the power converting apparatus 11 implements both of the active scheme and the passive scheme as the isolated operation detection feature, it is assumed that, at the normal time, only the isolated operation feature by the active scheme validly works and the feature by the passive scheme is stopped. FIG. 8 is a flowchart showing the second process in the first embodiment.

(Step S401) First, the wattmeter 15 measures the power value, and sends the measured value to the power converting apparatus 11.
(Step S402) Next, the dead band judging unit 112 of the power converting apparatus 11 judges whether the combination of the measured value of the active power and the measured value of the reactive power is within the set range.
(Step S403) In the case of judging that the combination of the measured value of the active power and the measured value of the reactive power is not within the set range in step S402, the power converting apparatus 11 performs the power conversion, and outputs the alternating-current power after the conversion. Then, some of the alternating-current power after the conversion is consumed in the load 13, and the residual alternating-current power is supplied to the power system 2.
(Step S404) In the case of judging that the combination of the measured value of the active power and the measured value of the reactive power is within the set range in step S402, the target value “Q_{ref}” of the reactive power is altered. This alteration is an example of the active scheme.
(Step S405) The isolated operation detecting unit 118 judges whether the frequency of the voltage measured by the measuring unit 114 is away from a predetermined range.
(Step S406) In the case of judging that the frequency of the voltage measured by the measuring unit 114 is away from the predetermined range in step S405, the isolated operation detecting unit 118 makes the judgment of being the isolated operation.
(Step S407) Subsequently to step S406, the power converting apparatus 11 stops the output.
(Step S408) In the case of judging that the frequency of the voltage measured by the measuring unit 114 is within the predetermined range in step S405, the judgment of being not the isolated operation is made. Then, the power converting system S1 returns the process to step S401.

In the case where the combination of the measured value of the active power and the measured value of the reactive power is not within the set range, by stopping the feature by the active scheme, it is possible to keep the power conversion efficiency optimal, and to avoid unnecessary grid disturbance and mutual interference between apparatuses.

Here, in the case where the combination of the measured value of the active power and the measured value of the reactive power is within the set range in step S402, the active scheme to alter the target value “Q_{ref}” of the reactive power is concurrently used. However, without being limited to this, the higher harmonic wave is added to the monitoring object by the passive scheme, as well as the voltage and the frequency.

Further, as the active scheme, the target value “Q_{ref}” of the reactive power of the power converting apparatus is altered, but without being limited to this, it is allowable to manipulate, by communication, a load that is present in the local grid 1 and in which the impedance can be regulated by communication. Thereby, it is possible to obtain the same effect as the alteration of the target value “Q_{ref}” of the reactive power.

### (Content and Frequency of Communication)

As for contents of communication messages that are sent or received not only for the purpose of reporting that the local grid 1 has fallen within the dead band but also for the purpose of avoiding the dead band as the local grid, some formats are possible. For example, in some case, the wattmeter 15 merely writes the measured active power value “P_{SM}” and reactive power value “Q_{SM}” in a message, and sends it.

Here, the wattmeter 15 may send a message indicating the falling within the dead band or the closing to the dead band, and may send the target value of the active power and the target value of the reactive power for avoiding the dead band, by communication.

The timing of the communication may be by a polling scheme in which the sending and receiving of messages are performed every constant time, or may be by an event driven scheme in which the communication start is triggered by the falling within the dead band or the closing to the dead band of the power value measured by the wattmeter 15.

In the case of the event driven scheme, it is possible to immediately execute the operation for the dead band avoidance even when closing to the dead band, and further to efficiently use the communication band by suppressing unnecessary communications at the stationary time. A communication start timing in which the polling and the event driven are concurrently used may be adopted. As the format of the communication message, binary data such as ECHONET Lite, text-based data formats such as XML, and the like are possible. Whichever format is used, the embodiment can be applied.

### Effect of First Embodiment

Thus, in the first embodiment, the acquiring unit 21 acquires, by communication, the measured value of the active power and the measured value of the reactive power from the wattmeter 15. The dead band judging unit 112 judges whether the combination of the measured value of the active power and the measured value of the reactive power acquired by the acquiring unit 21 is within the set range previously set.

In the case where the dead band judging unit 112 makes the judgment of being within the set range, the power target value determining unit 113 determines the target value of the alternating-current power to be output by the power converting apparatus 11, which is used when the power converting apparatus 11 controls the output power.

Therefore, when the power output of the local grid 1 is close to the dead band, the power target value determining unit 113 alters the target value of the alternating-current power to be output by the power converting apparatus 11, so that the alternating-current power to be output by the power converting apparatus 11 is altered. Thereby, it is possible to avoid the falling into a state in which the transfer of the active power and reactive power between the local grid 1 and the power system 2 is zero.

### Modification of First Embodiment

Here, the wattmeter 15 may send a warning indicating the dead band, to the power converting apparatus 11 by communication, when detecting that the measured value of the active power is 0 and the measured value of the reactive power is 0, namely that the transfer of the active power and reactive power between the local grid 1 and the power system 2 is 0. The power converting apparatus 11 having received this warning may alter the output for avoiding the dead band. The output is altered, for example, by the increase or decrease in the active power, the increase or decrease in the reactive power, or the like. Further, if the output voltage of the power converting apparatus 11 can be arbitrarily set, it is allowable to increase or decrease the power to be consumed in the load 13, by altering the output voltage of the power converting apparatus 11, and thereby avoid the dead band.

### (Avoidance of Dead Band by Operation of Load)

Since the dead band is a state in which the power supply and power consumption in the local grid 1 balance, it is only necessary to disrupt this balance, for avoiding the output power of the local grid 1 from falling within the dead band. To do this, it is effective to increase or decrease the supply amount of an apparatus to perform the power supply, or to increase or decrease the power consumption amount of the load 13. Examples thereof include the increase or decrease in the power consumption amount of the load 13 such as air conditioning equipment and lights, the increase or decrease in the input and output power of a storage battery, and the like.

When an apparatus such as a reactive power compensating apparatus is present, or when an impedance such as a phase advancing condenser is prepared, it is allowable to perform a manipulation such as the execution of the operation, stop, connection or disconnection of them. Thereby, it is possible to avoid the output power of the local grid 1 from falling within the dead band.

### (Control Based on Evaluation Function)

The power target value determining unit 113 of the power converting system S1 may calculate the value of an evaluation function to evaluate how close the combination of the measured value “P_{SM}” of the active power and the measured value “Q_{SM}” of the reactive power is to the dead band, and may determine the target value of the alternating-current power to be output by the power converting apparatus 11, depending on the calculated value of the evaluation function. For example, the power target value determining unit 113 may change the alteration amount of the power target value by the power target value determining unit 113, depending on the value of the evaluation function. For example, the power target value determining unit 113 may more increase the alteration amount of the power target value as the measured value “P” of the active power and the measured value “Q” of the reactive power get closer to zero.

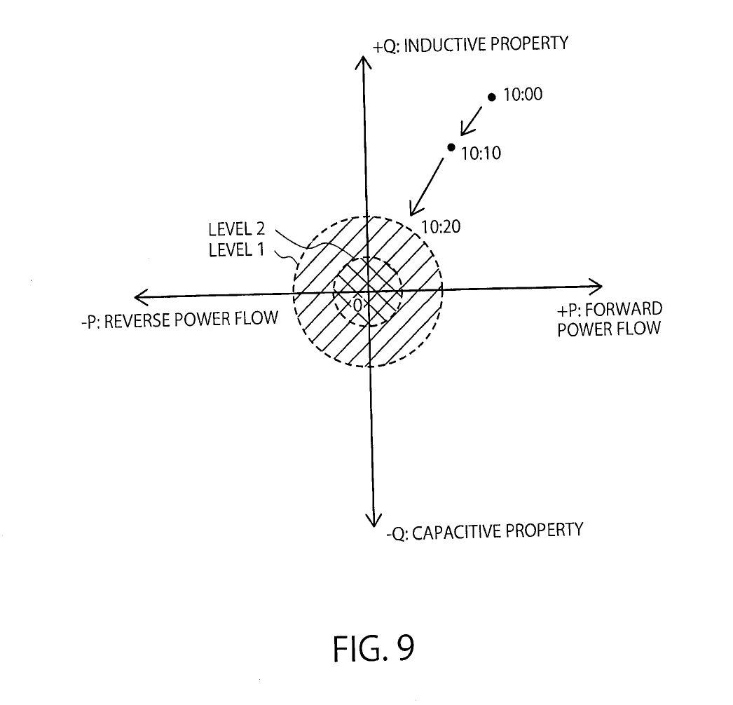

FIG. 9 is a diagram for explaining a control based on the evaluation function. The explanation will be made using a coordinate system shown in FIG. 9 in which the abscissa indicates the active power “P” and the ordinate indicates the reactive power “Q”. As an example, the evaluation function involves the distance “r=(P²+Q²)^{1/2}” from the origin of the coordinate system. The power target value determining unit 113 may alter the target value “P_{ref}” of the active power and the target value “Q_{ref}” of the reactive power such that “(P, Q)” changes in a direction away from the origin, using the distance “r” as the potential.

The power target value determining unit 113 may determine the target value “P_{ref}” of the active power and the target value “Q_{ref}” of the reactive power, depending on the coordinates of the measured value “P_{SM}” of the active power and the measured value “Q_{SM}” of the reactive power, which are acquired by the acquiring unit 21, and the distance “r” from the dead band. Further, the power target value determining unit 113 may evaluate the closeness to the dead band in levels and in stages, depending on the value of the distance “r”, and may switch the alteration amount of the target value “P_{ref}” of the active power or the target value “Q_{ref}” of the reactive power, depending on the level.

The example in FIG. 9 shows a range of level 1, and a range of level 2 that is narrower than the range of level 1. As shown in FIG. 9, when the coordinates of the measured value “P_{SM}” of the active power and the measured value “Q_{SM}” of the reactive power fall within the range of level 1, the power target value determining unit 113 alters the target value “P_{ref}” of the active power or the target value “Q_{ref}” of the reactive power by a first alteration amount. When the coordinates of the measured value “P_{SM}” of the active power and the measured value “Q_{SM}” of the reactive power fall within the range of level 2, the power target value determining unit 113 alters the target value “P_{ref}” of the active power or the target value “Q_{ref}” of the reactive power by a second alteration amount that is more than the first alteration amount.

Here, without being limited to this, the power target value determining unit 113 may more increase the alteration amount of the target value of the alternating-current power, as the combination of the measured value “P_{SM}” of the active power and the measured value “Q_{SM}” of the reactive power acquired by the acquiring unit 21 gets closer to the dead band.

Further, the conversion controlling unit 115 may calculate the value of the evaluation function to evaluate how close the combination of the measured value “P_{SM}” of the active power and the measured value “Q_{SM}” of the reactive power is to the dead band, and may switch the control depending on the calculated value of the evaluation function. For example, the conversion controlling unit 115 may alter the proportionality coefficient and integration coefficient of the above-described transfer function, depending on the value of the evaluation function.

Further, the conversion controlling unit 115 may evaluate the closeness to the dead band in levels and in stages, depending on the value of the distance “r”, and may perform the control differently depending on the level. For example, the conversion controlling unit 115 may use the transfer function differently depending on the level, and as an example thereof, may alter the proportionality coefficient or integration coefficient included in the transfer function, depending on the level. Further, for example, the conversion controlling unit 115 may determine the control scheme depending on the level, and as an example thereof, may use the PI control or the PID control properly depending on the level. Further, the conversion controlling unit 115 may perform such a control that “(P, Q)” goes in a direction away from the origin, using the value of the distance “r” as the potential.

Here, the evaluation function may be “r′=((aP)²+(bQ)²)^{1/2}”, in which “P” and “Q” have been weighted (“a” and “b” are coefficients).

Further, the power target value determining unit 113 or the conversion controlling unit 115 may predict whether the output power of the local grid 1 will fall within the dead band in the future, from a manner of previous changes in the measured value “P_{SM}” of the active power and the measured value “Q_{SM}” of the reactive power, and may avoid it in advance.

In FIG. 9, which shows coordinates of the measured value “P_{SM}” of the active power and the measured value “Q_{SM}” of the reactive power on a 10-minute basis from 10:00, they fall within the range of level 1 at 10:20. For example, when the latest power use amount that can be measured by the wattmeter 15 transits as shown in FIG. 9, it is anticipated that the local grid 1 will fall within the dead band in the course of time. In such a case, it is allowable to enhance the operation of an inductive load such as a motor and to shift the use power point “(P, Q)” in the “+Q” direction. Also, it is allowable to switch the storage battery during charge to discharge and to largely shift the use power point “(P, Q)” to the “−P” side. By executing them, it is possible to avoid the output power of the local grid 1 from falling within the dead band.

The alteration of the input or output of the active power is directly linked to the increase or decrease in power price. Therefore, in the embodiment, it is desirable that the conversion controlling unit 115 preferentially control the measured value “Q_{SM}” of the reactive power in a direction away from 0, in the control for avoiding “(P, Q)=(0, 0)”.

In the prediction of the measured value “P_{SM}” of the active power and the measured value “Q_{SM}” of the reactive power, the power target value determining unit 113 or the conversion controlling unit 115 may predict the power generation amount of a solar panel, based on weather prediction, sunshine duration and the like. Then, the power target value determining unit 113 or the conversion controlling unit 115 may predict the power consumption of an air conditioner or a light based on air temperature change, weather prediction, sunshine duration or the like. Then, the power target value determining unit 113 or the conversion controlling unit 115 may predict the measured value “P_{SM}” of the active power and the measured value “Q_{SM}” of the reactive power comprehensively, for example, from the prediction of the power generation amount of the solar panel and/or the prediction of the power consumption of the air conditioner or the light, along with the history of the measured value “P_{SM}” of the active power and the measured value “Q_{SM}” of the reactive power.

As the algorithm for the dead band avoidance when it is anticipated by the prediction that the local grid 1 will fall within the dead band, the power target value determining unit 113 may set the target value of the active power and the target value of the reactive power in a direction away from the dead band, or the conversion controlling unit 115 may perform the control in consideration of electricity prices and the like as parameters.

Here, in the embodiment, the dead band judging unit 112 judges whether the combination of the measured value of the active power and the measured value of the reactive power is within the set range previously set. At night, the fluctuation in the use power is small, and therefore, the set range may be narrowed down. Thus, the set range may be determined depending on the hour.

(Substitution for Wattmeter: Mode in which Load or Power Converting Apparatus has Power Measurement Feature)

In the embodiment, the wattmeter to be utilized for the measurement of the active power and the reactive power is not necessarily required to be independent as an apparatus. The power converting apparatus 11 may incorporate a measurement feature of the voltage and the current, and may calculate the power value. Further, there are household electric appliances that are compatible with a HEMS or ECHONET Lite and that can refer to the measured value of consumed power by communication, and a load having such a wattmeter feature may be utilized instead of the wattmeter. Thus, when the power converting apparatus or load having a power measurement feature is utilized, the power converting system S1 can acquire the measured value of the active power and the measured value of the reactive power, even if a wattmeter is not actually present in the local grid 1.

### (Direct Current Grid)

So far, the explanation has been made using the examples of the alternating-current grid. As for this, a single-phase alternating current, a three-phase alternating current, and a polyphase alternating current with more phases are all allowable. Further, even when the power system and the local grid involve direct current, or even when the local grid and the power system are different in alternating current/direct current, or the number of phases, the technique according to the first embodiment can be applied. Since there is no concept of the reactive power “Q” in direct current, the dead band judging unit 112 judges whether only the active power “P” is within a set range.

For example, suppose that FIG. 1 is replaced by a direct-current grid. In this case, the power converting apparatus 11 corresponds to a converter or the like. The dead band of the local grid 1 is a state in which the output of the power converting apparatus 11 balances with the consumed power of the load 13, and the dead band can be judged by whether the power “P” passing through the wattmeter 15 is 0. Therefore, for example, the dead band judging unit 112 may judge whether the power “P” passing through the wattmeter 15 is within a set range previously set. This set range is a range containing 0.

For avoiding the dead band, it is allowable to perform a manipulation such as an increase or decrease in the output active power of the power converting apparatus 11, or an increase or decrease in the consumed active power of the load 13. When the output voltage from the local grid 1 can be arbitrarily set, the output of the power converting apparatus 11 may be changed such that the voltage is shifted up or down. Also, the power to be consumed in the load 13 may be changed.

### Second Embodiment

Next, a second embodiment will be described. In the first embodiment, the power converting apparatus 11 judges whether the combination of the measured value of the active power and the measured value of the reactive power is within the set range previously set, and alters the target value of the alternating-current power in the case of the judgment of being within the set range. On the contrary, in the second embodiment, the above-described process is performed by an EMS server, instead of the power converting apparatus 11.

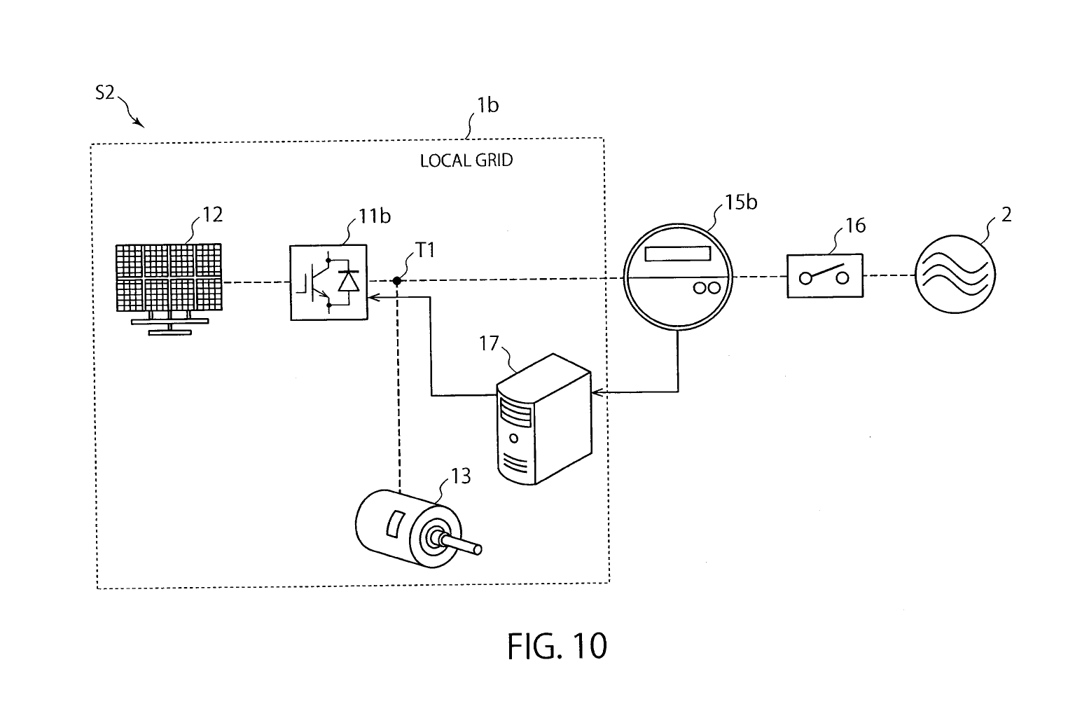

FIG. 10 is a diagram showing the configuration of a power converting system S2 according to the second embodiment. Relative to the configuration of the power converting system S1 according to the first embodiment, in the configuration of the power converting system S2 according to the second embodiment, the power converting apparatus 11 is altered into a power converting apparatus 11b, the wattmeter 15 is altered into a wattmeter 15b, and an EMS server 17 is added. Here, for elements in common with FIG. 1, the same reference characters are assigned, and the concrete explanations are omitted.

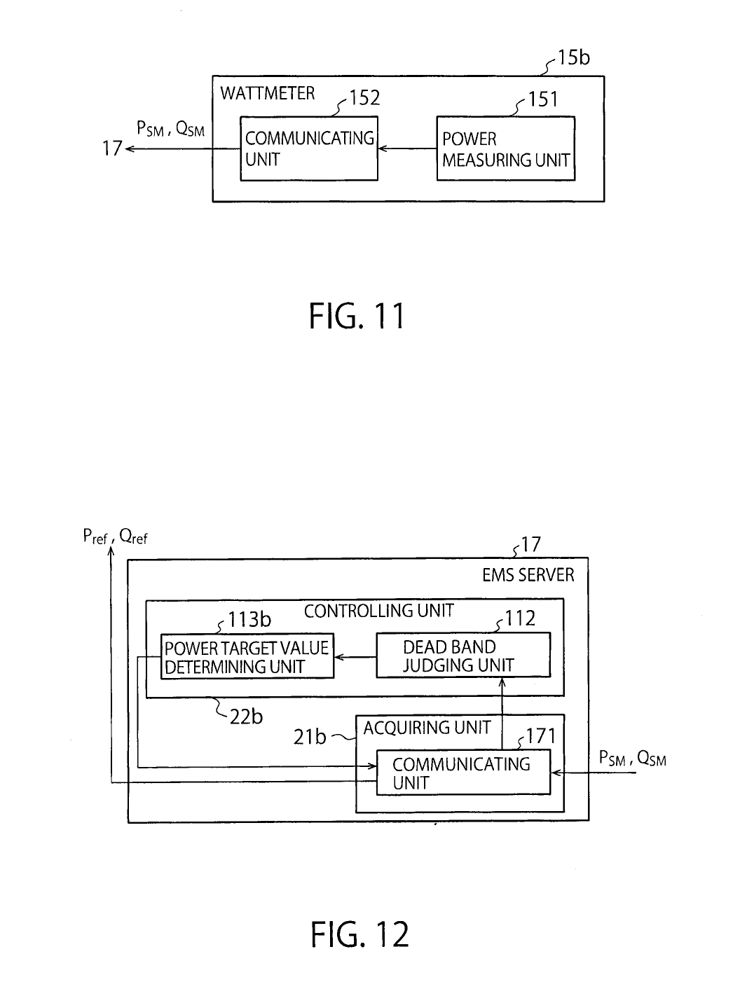

The wattmeter 15b has a similar feature to the wattmeter 15 according to the first embodiment, but there is a difference in that the wattmeter 15b sends the measured value “P_{SM}” of the active power and the measured value “Q_{SM}” of the reactive power, to not the power converting apparatus 11 but the EMS server 17. FIG. 11 is a diagram showing the configuration of the wattmeter 15b according to the second embodiment. Concretely, as shown in FIG. 11, the wattmeter 15b includes the power measuring unit 151 and the communicating unit 152. The power measuring unit 151 has a similar feature to the first embodiment. The communicating unit 152 has a similar feature to the first embodiment, but has a difference in that it sends the measured value “P_{SM}” of the active power and the measured value “Q_{SM}” of the reactive power, to not the power converting apparatus 11b but the EMS server 17.

As shown in FIG. 10, the EMS server 17 acquires, by communication, the measured value “P_{SM}” of the active power and the measured value “Q_{SM}” of the reactive power, from the wattmeter 15b. Then, the EMS server 17 determines the target value “P_{ref}” of the active power and the target value “Q_{ref}” of the reactive power, using the measured value “P_{SM}” of the active power and the measured value “Q_{SM}” of the reactive power that have been acquired. Then, the EMS server 17 sends, to the power converting apparatus 11b, the target value “P_{ref}” of the active power and the target value “Q_{ref}” of the reactive power that have been determined.

FIG. 12 is a diagram showing the configuration of the EMS server 17 according to the second embodiment. The EMS server 17 includes an acquiring unit 21b and a controlling unit 22b. The acquiring unit 21b includes a communicating unit 171. The controlling unit 22b includes a dead band judging unit 112 and a power target value determining unit 113b.

The dead band judging unit 112 has a similar feature to the dead band judging unit 112 according to the first embodiment. The power target value determining unit 113b has a similar feature to the power target value determining unit 113 according to the first embodiment, and further, has a feature for outputting the measured value “P_{SM}” of the active power and the measured value “Q_{SM}” of the reactive power after the determination, to a communicating unit 171.

The communicating unit 171 sends the target value “P_{ref}” of the active power and the target value “Q_{ref}” of the reactive power, to the power converting apparatus 11b. Further, the communicating unit 171 acquires, by communication, the measured value “P_{SM}” of the active power and the measured value “Q_{SM}” of the reactive power, from the wattmeter 15b, and outputs these acquired values to the controlling unit 22b.

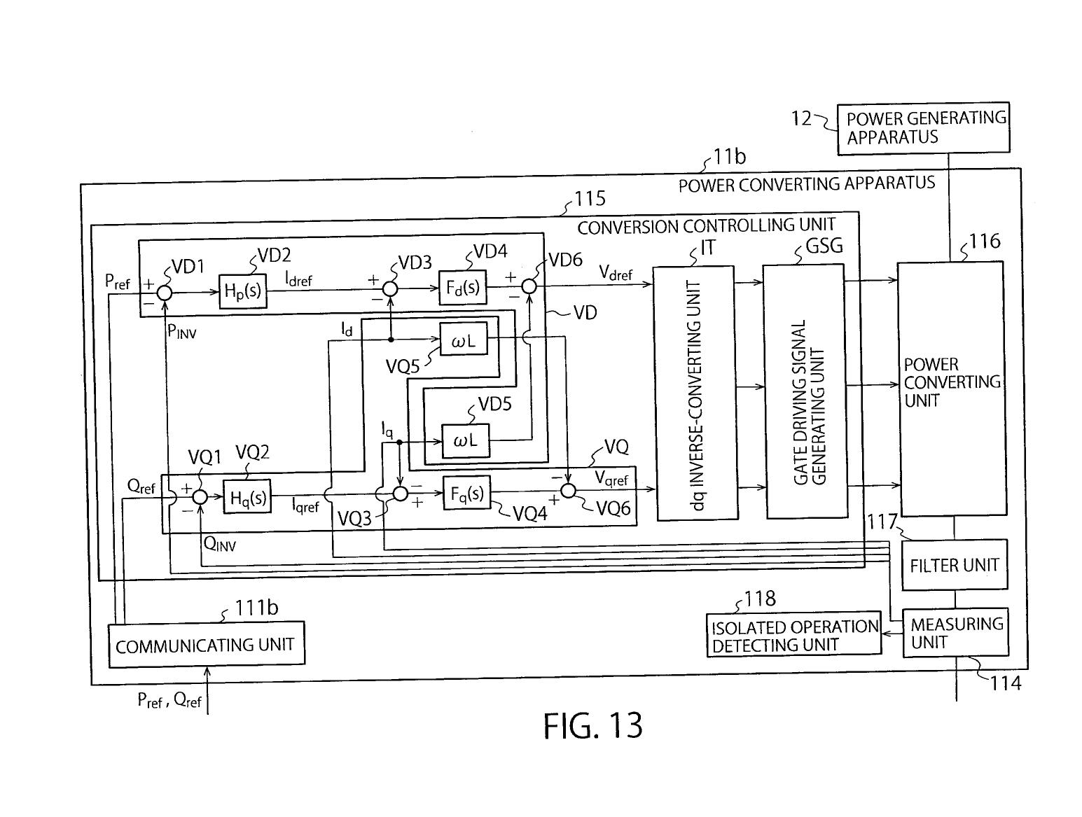

FIG. 13 is a diagram showing the configuration of the power converting apparatus 11b according to the second embodiment. Relative to the configuration of the power converting apparatus 11 (see FIG. 4) according to the first embodiment, in the configuration of the power converting apparatus 11b according to the second embodiment, the acquiring unit 21 and the controlling unit 22 are removed, and a communicating unit 111b is added. Here, for elements in common with FIG. 4, the same reference characters are assigned, and the concrete explanations are omitted.

The communicating unit 111b acquires, by communication, the target value “P_{ref}” of the active power and the target value “Q_{ref}” of the reactive power, from the EMS server 17, and outputs these acquired values to the conversion controlling unit 115.

### Effect of Second Embodiment

Thus, according to the second embodiment, the acquiring unit 21b of the EMS server 17 acquires, by communication, the measured value of the active power and the measured value of the reactive power, from the wattmeter 15b. The dead band judging unit 112 of the EMS server 17 judges whether the combination of the measured value of the active power and the measured value of the reactive power acquired by the acquiring unit 21b is within the set range previously set. In the case where the dead band judging unit 112 makes the judgment of being within the set range, the power target value determining unit 113 of the EMS server 17 alters the target value of the alternating-current power to be output by the power converting apparatus 11b, which is used when the power converting apparatus 11b controls the output power.

Thus, when the power output of the local grid 1b is close to the dead band, the power target value determining unit 113 alters the target value of the alternating-current power to be output by the power converting apparatus 11b, and thereby, the alternating-current power to be output by the power converting apparatus 11b is altered. Thereby, it is possible to avoid the power output of the local grid 1b from falling within the dead band.

### Third Embodiment

### About Virtual Wattmeter

A third embodiment assumes an intangible and virtual wattmeter (hereinafter, referred to as a virtual wattmeter) that collects the voltages and currents, or the powers measured by other wattmeters or power converting apparatuses by communication to sum them, and regards the resulting power value as the measured value.

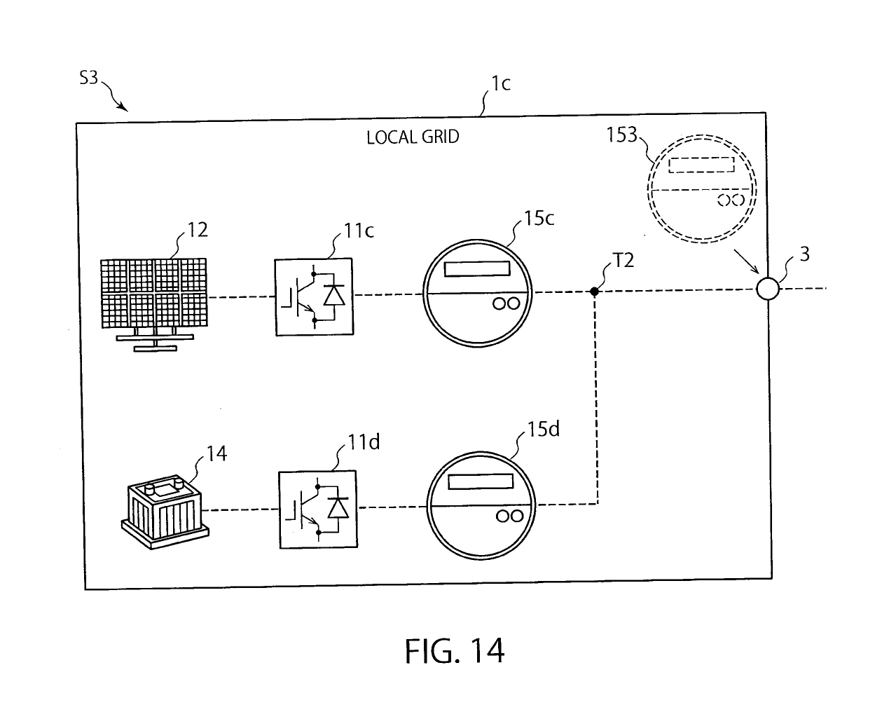

FIG. 14 shows the configuration for explaining a virtual wattmeter. In FIG. 14, a local grid 1c includes the power generating apparatus 12 in which the output is connected with an input of a power converting apparatus 11c by a power line, and the power converting apparatus 11c in which an output is connected with an interconnecting point 3 through a connecting point T2. Here, the interconnecting point 3 is a point for interconnecting with the power system. Furthermore, the local grid 1c includes a power storing apparatus 14 in which an output is connected with an input of a power converting apparatus 11d by a power line, and the power converting apparatus 11d in which an output is connected with the interconnecting point 3 through the connecting point T2. A wattmeter 15c measures the power value from a power line that links the power converting apparatus 11c and the connecting point T2. A wattmeter 15d measures the power value from a power line that links the power converting apparatus 11d and the connecting point T2.

For example, when the configuration of the power lines and the arrangement of the wattmeters are in a situation shown in FIG. 14, even if a wattmeter is not actually installed at the interconnecting point 3, the measured values of the wattmeters 15c, 15d are acquired by communication, and thereby, the power passing through the interconnecting point 3 can be calculated.

In this case, assuming that a virtual wattmeter 153 is installed at the interconnecting point 3, the measured value of the virtual wattmeter 153 is regarded as the sum value of the wattmeters 15c, 15d. Thereby, it is possible to judge whether the output power of the local grid 1c is within the set range, using the measured value of the virtual wattmeter 153.

This virtual wattmeter 153 is a conceptual wattmeter for simplifying the above judgment and the calculation of the power amount. Therefore, the power converting system may merely sum the measured values, without the approach and process of the virtual wattmeter.

The power storing apparatus 14 is an apparatus that converts electric energy into a different energy form and preserves it, and for example, is a battery. It can be said that a storage battery or an electric automobile (EV: Electric Vehicle) equipped with a storage battery is an example of the power storing apparatus, but the power storing apparatus 14 includes a dry battery, which is under the premise that it performs only discharge after production, and the like. In some cases, for the management of the charge and discharge speed, the battery deterioration and the life, the power storing apparatus 14 is equipped with a controlling system configured by power transforming components such as a microcomputer, a regulator and an inverter. The power transforming or controlling system is called a PCS (Power Conditioning System). Further, a storage battery integrated with the PCS is sometimes called a BESS (Battery Energy Storage System). In some cases, the PCS is attached to not only a storage battery but also a solar power generator, other small-size power generators and the like. Application examples of the power storing apparatus include a water tower that, in a broad sense, can be interpreted to preserve electric energy as potential energy, an uninterruptible power source apparatus, and the like. Also, a flywheel or the like that allows for derivation of power from accumulated kinetic energy can be interpreted as a kind of power storing apparatus. Further, the storage battery during charge can be regarded as a kind of load, and the storage battery during discharge can be regarded as a kind of power generating apparatus.

### (About Statistical Process of Measured Value Error and Uncertainty)

The measured value involves errors and statistical uncertainty. Therefore, for example, when the uncertainty of the measured value of the wattmeter is already known, the dead band judging unit 112 may judge the dead band in consideration of the uncertainty.

When the measured value of the virtual wattmeter is calculated on the basis of the measured values of a plurality of wattmeter, the uncertainty of the measured value of the virtual wattmeter depends on, as the basis therefor, the number of wattmeters and the uncertainties of the respective measurements. Therefore, particularly, when the number of wattmeters, which is an element for the sum, is large, there is a probability that the uncertainty is not negligible.

In FIG. 14, for example, suppose that the measured values of the two wattmeters 15c, 15d are summed as the measured value of the virtual wattmeter 153. If the measurement accuracy of the wattmeter 15d is low, the measurement accuracy of the virtual wattmeter 153 is also low, even if the wattmeter 15c is an apparatus capable of accurately measuring the power. It can be thought that the error and uncertainty of the measured value of the virtual wattmeter 153 is obtained by statistically calculating the errors and uncertainties of the wattmeters 15c, 15d. As an example of the calculation, the standard uncertainty, that is, the standard deviation is used as the uncertainty of the measurement. On this occasion, when the standard deviations of the measurements by the wattmeter 15c, 15d are “σₐ” and “σ_{b}^{”} respectively, the uncertainty of the measurement by the virtual wattmeter 153 is the square root of the sum of the squares of the standard deviations, “√(σₐ²+σ_{b}²)”.

### (Measured Value Calculation for Virtual Wattmeter in Consideration of Measurement Timing)

The power to flow out of or into the local grid 1 changes depending on time, and therefore, when the virtual wattmeter is used, it is necessary to consider the deviation in the measurement timings of the wattmeters that are elements of the measured value. For example, suppose that the wattmeters 15c, 15d in FIG. 14 are apparatuses to send the measured values of the powers at a frequency of once every 10 minutes. If the sending timings of the two wattmeters are the same, the sum for the wattmeters 15c, 15d can be regarded as the measured value of the virtual wattmeter 153. However, when the sending timings of the measured values of the two wattmeters deviate from each other by 5 minutes, the simple sum of these measured values cannot be regarded as the measured value of the virtual wattmeter 153.

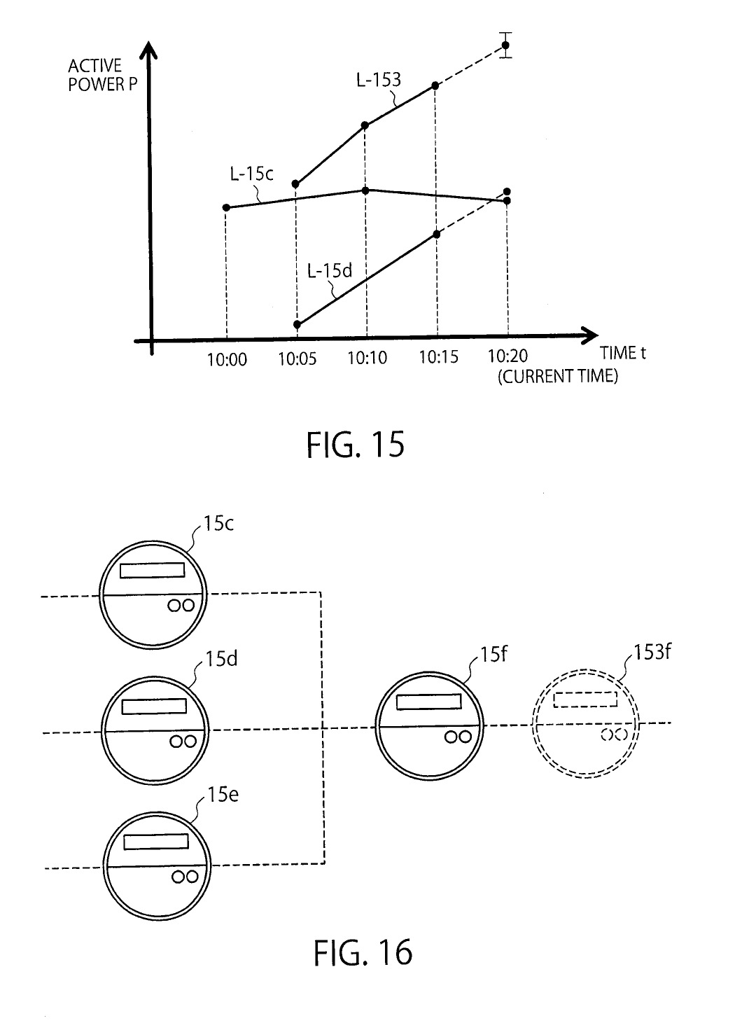

FIG. 15 is a diagram for explaining a calculation method of the measured value of the virtual wattmeter 153. FIG. 15 shows a line graph L-15c indicating a time series change in the active power “P” measured in the wattmeter 15c, a line graph L-15d indicating a time series change in the active power “P” measured in the wattmeter 15d, and a line graph L-153 indicating a time series change in the active power “P” in the virtual wattmeter 153. For example, when the measured values of the active powers “P” of the wattmeters 15c, 15d are as FIG. 15, the measured value of the wattmeter 15d is unknown at the current time (10:20), and therefore, the measured value of the virtual wattmeter 153 is also unknown. On this occasion, the acquiring unit 21 or 21b may estimate the current measured value from a measured value history of the wattmeter 15d, using a previously determined estimation technique, and based on the measured value, may estimate the measured value of the virtual wattmeter 153.

As an example of the estimation technique, the measured value “p_{b05}” of the wattmeter 15d at the current time (10:20) is obtained by substituting “t=10:20” into a linear function “p_{b05}=m_{b05}t+n_{b05}” with respect to time “t” that is derived from recent measured values (10:05 to 10:15). Here, “m_{b05}” and “n_{b05}” are coefficients. Then, the measured value of the virtual wattmeter 153 at the current time is determined as the sum of the measured value of the wattmeter 15c at the current time and the estimated value of the wattmeter 15d. Thus, as an example, the acquiring unit 21 or 21b estimates a first output power at a predetermined time, based on first output powers at a plurality of times, and then, as the reverse flow power value at the predetermined time, acquires the sum of the estimated first output power at the predetermined time and a second output power at the predetermined time.

Further, as another example, which focuses attention on only a measurement history of the virtual wattmeter 153, the acquiring unit 21 or 21b substitutes “t=10:20” into a linear function “p_{ab10}=m_{ab10}t+n_{ab10}” with respect to time “t” that is derived from the recent 5 minute section (10:10 to 10:15), and thereby, estimates the measured value of the virtual wattmeter 153 at the current time. Here, “m_{ab10}” and “n_{ab10}” are coefficients. Thus, the acquiring unit 21 or 21b estimates the reverse flow power value at the predetermined time, based on the reverse flow power values at the plurality of times.

Here, when the measured value of the virtual wattmeter is determined by the estimation, it should be noted that the uncertainty of the measured value is not a simple composition of the respective uncertainties for the measured values of the wattmeters. The above is a simple example of the estimation technique, and the acquiring unit 21 or 21b may calculate the power value, using a different estimation technique.

Thus, in the third embodiment, the local grid 1c includes the power converting apparatus 11c and power converting apparatus 11d that are connected with the power system in parallel with each other. The acquiring unit 21 or 21b acquires, by communication, the measured value of the first output power to be output to the power system by the first power converting apparatus 11c, from the wattmeter 15c, and acquires, by communication, the measured value of the second output power to be output to the power system by the power converting apparatus 11d, from the second wattmeter 15d. The acquiring unit 21 or 21b estimates the reverse flow power value to be supplied to the power system by the local grid 1c, based on the first output power and the second output power.

Thereby, even when the power converting apparatus 11c and the power converting apparatus 11d are different in measurement timing, it is possible to estimate the reverse flow power value to be supplied to the power system by the local grid 1c.

### (Application of Virtual Wattmeter: Backup, Abstraction)

In the local grid and the power system, the approach of the virtual wattmeter can be applied to uses other than the dead band. For example, the virtual wattmeter can be used for detecting the failure of an existing wattmeter, and the explanation thereof will be made using FIG. 16. FIG. 16 is an installation example of wattmeter. When four wattmeters are installed by the configuration as FIG. 16, a virtual wattmeter 153f in which the measured value is the sum value of the measured values of wattmeters 15c, 15d, 15e is assumed. If all the apparatus properly operate, the measured values of the virtual wattmeter 153f and a wattmeter 15f must be coincide in a range of the uncertainty and the measuring apparatus error.

Meanwhile, when the measured values are significantly inconsistent, the failure of one of the wattmeters 15c, 15d, 15e 15f can be suspected. Further, the virtual wattmeter integrates the measured values and the influences of the impedances for the plurality of wattmeters, and thereby, it is possible to utilize it as an abstraction layer for the exterior of the local grid. As shown in FIG. 16, when the wattmeter 15f is not installed, by assuming the virtual wattmeter 153f, it is possible to hide the presence of the wattmeters 15c, 15d, 15e, which are present closer to the local grid. That is, in a viewpoint from the exterior of the local grid, the three wattmeters 15c, 15d, 15e can be regarded as the single virtual wattmeter 153f. Therefore, in a viewpoint from the exterior of the local grid, an effect by which the number of nodes of the wattmeters is reduced from three to one can be expected.

The respective wattmeters 15c, 15d, 15e calculate the measured values, including the uncertainties and the like. On that occasion, the acquiring unit 21 or 21b determines the respective standard deviations of the measurements by the wattmeters 15c, 15d, 15e, as the uncertainties, and regards the sum of the squares of the standard deviations, as the uncertainty of the virtual wattmeter 153f, for example. Thereby, the power system side only has to comprehend the uncertainty of the virtual wattmeter 153f, instead of the respective wattmeters. Therefore, for example, there is an advantage in that it is easy to deal with as a constituent element of a computer program system.

### Fourth Embodiment

### Example Using Pole-Mounted Transformer

Next, a fourth embodiment will be described. In the fourth embodiment, it is assumed that the alternating-current power of the power converting apparatus is transformed by a pole-mounted transformer, and is supplied to the power system. In this assumption, the power converting apparatus decreases the reactive power at an interconnecting point between the transformer and the power system, by the amount of the reactive power to be consumed in the pole-mounted transformer, and performs the control using the decreased reactive power.

When the impedance of the load is already known, the dead band can be judged including it. For example, in many cases, the pole-mounted transformer is present between a power transmitting network and the local grid, to perform the transformation. The pole-mounted transformer is an inductor on the electric circuit, and therefore, when a voltage is applied, a reactive current flows and a reactive power is generated. Therefore, the condition of the dead band judgment based on the power value differs depending on which of front and back interconnecting points to the pole-mounted transformer is assumed to be disconnected.

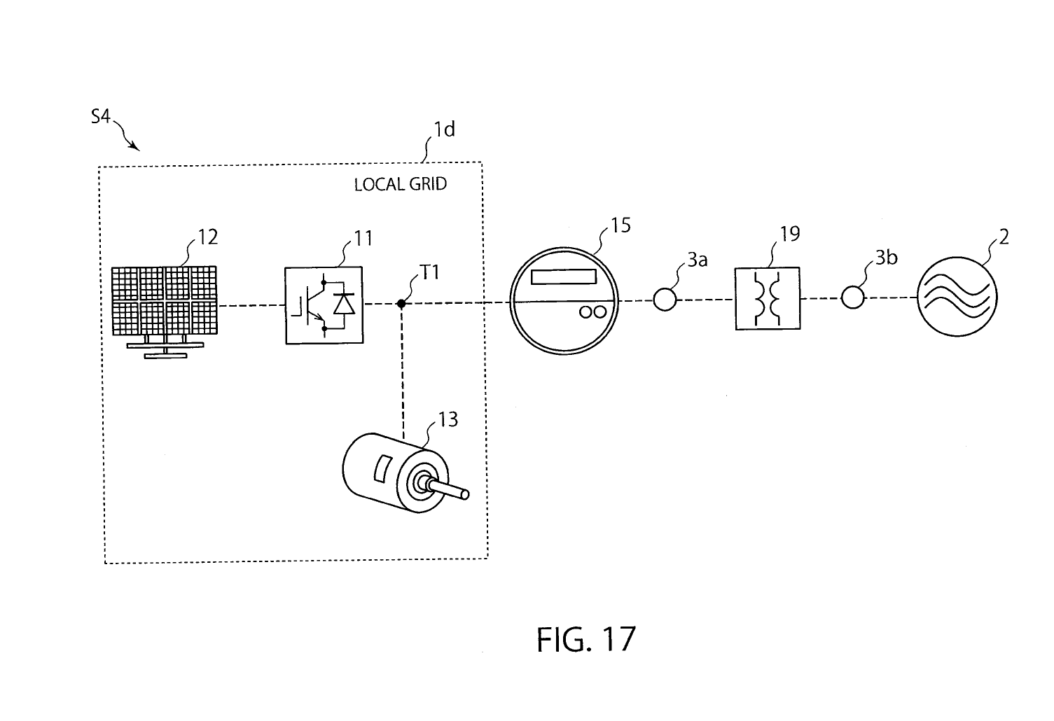

FIG. 17 is a diagram showing the configuration of a power converting system S4 according to the fourth embodiment. Relative to the power converting system S1 (see FIG. 1) according to the first embodiment, in the fourth embodiment, a pole-mounted transformer 19 is added. As shown in FIG. 17, suppose that a local grid 1d and the power system 2 are connected through the pole-mounted transformer 19. The power converting apparatus 11 according to the first and second embodiments judges the dead band by whether the active power “P” and reactive power “Q” passing through an interconnecting point are 0. Here, assuming the parallel-off at an interconnecting point 3a, since the power passing through the interconnecting point 3a is equal to the power passing through the wattmeter 15, it can be said that the dead band condition for the local grid 1d is the case where the active power “P” and reactive power “Q” to be measured by the wattmeter 15 are 0.

Meanwhile, due to the influence of the impedance of the pole-mounted transformer 19, the condition by which the active power “P” and reactive power “Q” passing through an interconnecting point 3b get to be 0 is different from the condition by which the active power “P” and reactive power “Q” passing through the wattmeter 15 get to be 0. Therefore, assuming that the interconnecting point 3b is the parallel-off point, the judgment of the dead band based on the measured value of the wattmeter 15 must be performed in consideration of the impedance of the pole-mounted transformer 19. On this occasion, for performing the judgment of the dead band, it may be assumed that a virtual wattmeter in which the measured value is a numerical value considering the impedance of the pole-mounted transformer 19 with respect to the measured value of the wattmeter 15 is at the interconnecting point 3b.

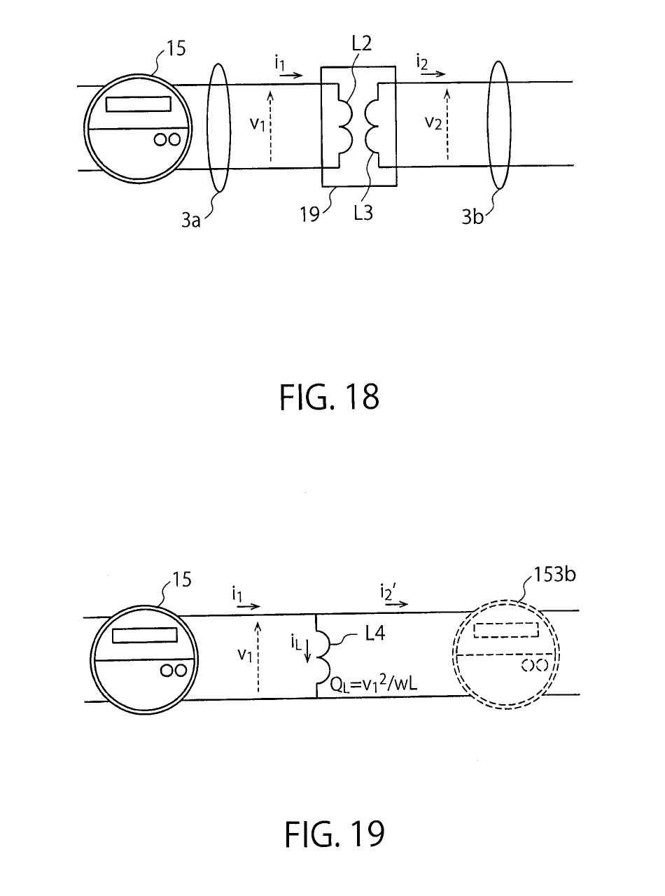

For example, in the case of a single phase, a circuit around the wattmeter 15 and pole-mounted transformer 19 in FIG. 17 is shown as FIG. 18. FIG. 18 is an equivalent circuit diagram of FIG. 17 in the case of a single phase. The pole-mounted transformer 19 includes an inductor L2 and an inductor L3 facing the inductor L2. The voltage between both terminals of the inductor L2 is “v₁”, and a current “i₁” flows into one terminal of the inductor L2. The voltage between both terminals of the inductor L3 is “v₂”, and a current “i₂” flows out of one terminal of the inductor L3.

FIG. 19 is an equivalent circuit diagram of the circuit in FIG. 18 from a viewpoint of the primary side (the local grid side). The current “i₁” output from the wattmeter 15 is divided into a current “i_{L}” flowing to an inductor L4 and a current “i₁′” flowing to a virtual wattmeter 153b. The inductance of the inductor L4 is “L”, and the voltage to be applied between both terminals of the inductor L4 is “v₁”. When the loss of the pole-mounted transformer 19 is ignored, a reactive power “Q_{L}=v₁²/ωL” corresponding to the inductance “L” of the inductor L4 flows in the pole-mounted transformer 19.

Thereby, the powers to be measured at the interconnecting points 3a and 3b are deviated by “Q_{L}”. Therefore, the dead band judging unit 112 judges whether the power at the interconnecting point 3b is within the set range, by whether a value “(P, Q−Q_{L})” considering “Q_{L}” with respect to the power measured value of the wattmeter 15 is within the set range.

To summarize the above configuration, the local grid 1d is connected with the power system through the pole-mounted transformer 19, and the acquiring unit 21 or 21b acquires, by communication, the measured value of the active power and the measured value of the reactive power, from the wattmeter. The dead band judging unit 112 judges whether the combination of the measured value of the active power acquired by the acquiring unit 21 or 21b, and the value resulting from subtracting the reactive power corresponding to the inductance of the pole-mounted transformer 19 from the measured value of the reactive power is within the set range previously set. Thereby, it is possible to judge whether the power at the interconnecting point 3a is within the set range, without installing a wattmeter at the interconnecting point 3a. Then, in the case where the power at the interconnecting point 3a is within the set range, the power target value determining unit 113 alters the target value of the alternating-current power to be output by the power converting apparatus, so that the alternating-current power to be output by the power converting apparatus changes, allowing for the avoidance of the dead band.

Here, when the loss, stray capacitance and others of the transformer and service wires are considered, a more accurate value can be calculated, but these values may be ignored if they are small.

Further, in FIG. 17, when the impedance of the load 13 is already known, the active power and reactive power of the load 13 can be calculated from the voltage to be measured in the power converting apparatus 11, that is, the voltage at the connecting point T1, and the already-known impedance of the load 13, and therefore, the active power and reactive power at the interconnecting point 3a are found without installing the wattmeter 15. Thereby, it is possible to judge whether the power at the interconnecting point 3a is within the set range, without installing the wattmeter 15.

Thus, when the impedance of the pole-mounted transformer or the like is present on the power line, the sum of the outputs of the plurality of wattmeters and the influence of the impedance are considered, even when the power line diverges. Therefore, the dead band judging unit 112 assumes a plurality of parallel-off points, and thereby, can judge whether the power at each parallel-off point is within the set range. Further, by performing such a calculation process, it is possible to avoid the output power of a local grid including a power converting apparatus with no communication feature or with an incompatible communication, or a power converting apparatus with unknown impedance, from falling within the set range. Accordingly, it does not fall within the dead band, and therefore, the isolated operation detecting unit 118 can perform an accurate and quick isolated operation detection.

### Fifth Embodiment

### About Local Grid Including a Plurality of Interconnecting Point

In a fifth embodiment, a local grid including two interconnecting points is assumed, and the power converting apparatus avoids the dead band at the two interconnecting points. There is a case where a single local grid is connected with a power system through a plurality of paths, such as a case of a large-scale factory that receives power from a single or a plurality of power systems through two transformer substations, a case of a facility such as a frequency converter station that is present midway between a plurality of power systems different in voltage, frequency or phase, for example between eastern Japan and western Japan, and that performs power exchange, and a case of a general transformer substation. Also in such a case, the feature of the isolated operation detection is sometimes necessary, and, also in such a case, the dead band is present.

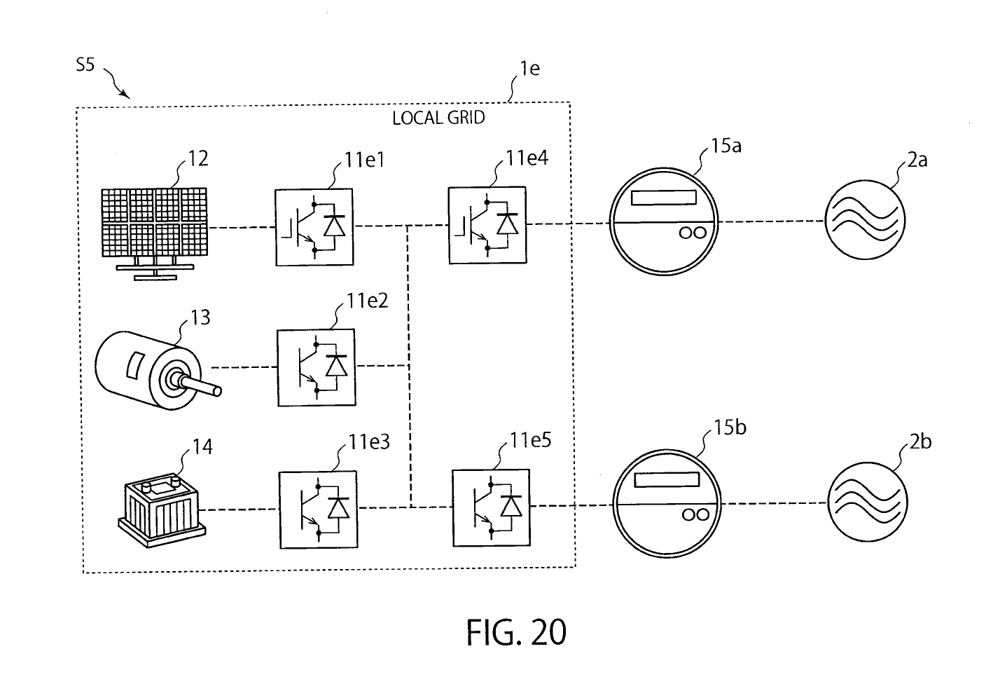

FIG. 20 is a diagram showing the configuration of a power converting system S5 according to the fifth embodiment. In FIG. 20, it is assumed that the whole of a factory interconnecting with two power systems is a single local grid 1e.

In both of the wattmeters 15a, 15b, when the active powers “P” and reactive powers “Q” to be detected are zero, the output powers of the local grid 1e to the two power systems are at the dead band.

When the active power “P” and reactive power “Q” of a wattmeter 15a are both 0 while a wattmeter 15b detects some power, the local grid 1e is at the dead band for a power system 2a, and is at the non-dead band for a power system 2b. In both cases, when a certain amount of power is transferred between the local grid 1e and the power systems 2a, 2b, the dead band can be avoided.

Further, power converting apparatuses 11e1 to 11e5 have a configuration similar to the power converting apparatus 11 shown in FIG. 4, and therefore, the concrete explanations are omitted.

In the following, an example of a process for avoiding the dead band will be described.

For example, the acquiring unit 21 of the power converting apparatus 11e4 acquires, by communication, the measured values of the active power “P” and reactive power “Q” by the wattmeter 15a, from the wattmeter 15a. The dead band judging unit 112 of the power converting apparatus 11e4 judges whether these measured values are within the set range. In the case where these measured values are within the set range, the power target value determining unit 113 alters the target value of the alternating-current power to be output by the power converting apparatus 11e4. In this way, the conversion controlling unit 115 of the power converting apparatus 11e4 controls the power converting unit 116 such that the output power is altered, based on the target value of the alternating-current power. Thereby, the output power of the power converting apparatus 11e4 is altered, and therefore, it is possible to avoid the output power of the power converting apparatus 11e4 from falling within the dead band. Furthermore, the measuring unit 114 of the power converting apparatus 11e4 measures the output power. The communicating unit 111 of the power converting apparatus 11e4 sends the alteration amount to the power converting apparatus 11e5.

The power converting apparatus 11e5 having received the alteration amount controls its own output power in the opposite direction to the alteration amount, by the same amount. Thereby, it is possible to equalize the power to flow into the local grid 1e through the power converting apparatus 11e4, with the power to flow out of the local grid 1e through the power converting apparatus 11e5. Therefore, it is possible to avoid the dead band, while zeroing the addition of the electricity price that is imposed on the administrator of the local grid 1e.

On this occasion, there is a probability that the active power to be supplied to the load 13 changes due to the alteration of the active power to be output by the power converting apparatus 11e4 or 11e5. Therefore, it is preferable to alter only the reactive power to be output by the power converting apparatus 11e4 or 11e5, without altering the active power to be output by the power converting apparatus 11e4 or 11e5. For example, the alteration amount of the reactive power of the power converting apparatus 11e4 and the alteration amount of the reactive power of the power converting apparatus 11e5 are equalized in absolute value and are opposed in sign.

Thus, in the power converting apparatus 11 according to the fifth embodiment, the local grid 1e has the plurality of power systems and the respective interconnecting points, and the plurality of power converting apparatuses are electrically connected with the power systems different from each other, respectively. The dead band judging unit 112 judges whether the combination of the measured value of the active power and the measured value of the reactive power that are supplied to one power system of the plurality of power systems is within the set range previously set. In the case where the dead band judging unit 112 makes the judgment of being within the set range, the conversion controlling unit 115 controls the power converting unit 116 such that the output power is altered. The measuring unit 114 measures the alteration amount of the output power altered by the conversion controlling unit 115. The communicating unit 111 of the power converting apparatus 11e4 sends the alteration amount measured by the measuring unit 114, to the power converting apparatus 11e5, which controls its own output power in the opposite direction to the alteration amount, by the same amount.

Thereby, the output power of the power converting apparatus 11e4 is altered, and therefore, it is possible to avoid the output power of the power converting apparatus 11e4 from falling within the dead band. Furthermore, it is possible to equalize the power to flow into the local grid 1e through the power converting apparatus 11e4, with the power to flow out of the local grid 1e through the power converting apparatus 11e5. Therefore, it is possible to avoid the dead band, while zeroing the addition of the electricity price that is imposed on the administrator of the local grid 1e.

### Sixth Embodiment

### About Compensation of Loss Associated with Dead Band Avoidance

Next, a sixth embodiment will be described. Even for the purpose of avoiding the dead band, the outputting of the reactive power causes the increase in the loss of the power converting apparatus, and, because of the suppression of the output active current by the reactive current, can lead to the decrease in the reverse flow amount of the active power of the power converting apparatus, and further to the decrease in the power selling profit. Further, the increase or decrease in the active power is one of the means for the dead band avoidance by the local grid, but this can result in the rise in a charge amount of electricity price, or the impairment of the maximization of the power selling profit, and it is difficult to gain customer understanding.

Hence, an EMS server in a power converting system according to the embodiment records the information (for example, the power amount or the electricity price) about the energy loss produced due to the dead band avoidance. Then, the EMS server requests, to an electricity price managing server 20, the compensation of a price equivalent to the energy loss, at the accounting time of the electricity price. Thereby, the compensated charge amount is claimed to the administrator of the local grid.

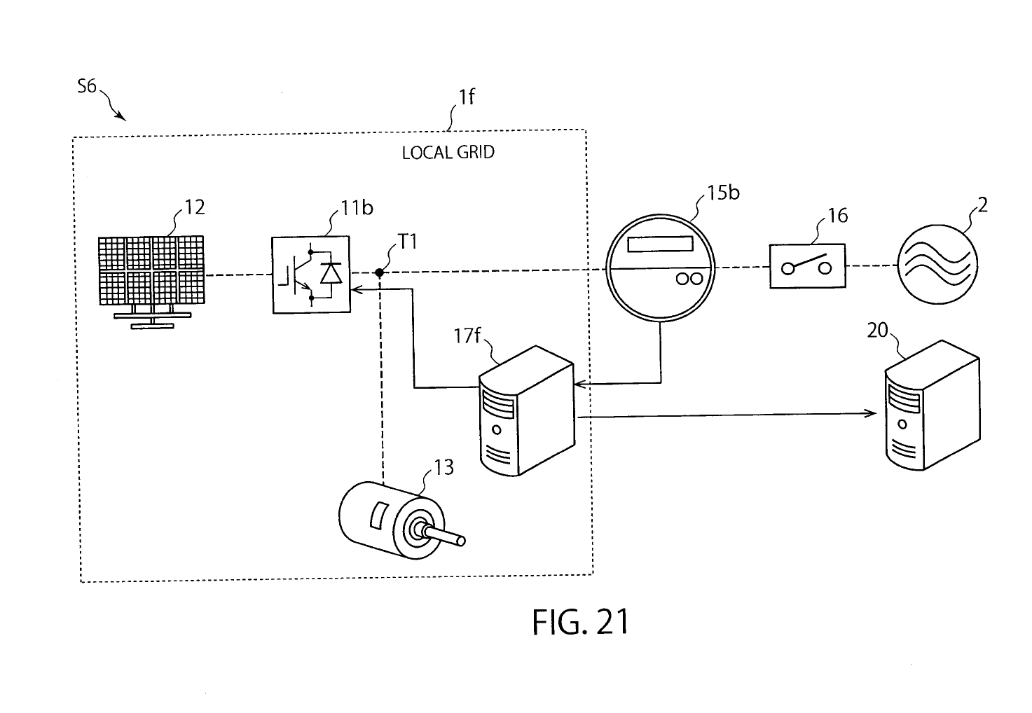

FIG. 21 is a diagram showing the configuration of a power converting system S6 according to the sixth embodiment. Compared to the power converting system S2 (see FIG. 10) according to the second embodiment, in the power converting system S6 according to the sixth embodiment, the electricity price managing server 20 is added, and the EMS server 17 is altered into an EMS server 17f. Here, for elements in common with FIG. 10, the same reference characters are assigned, and the concrete explanations are omitted.

The EMS server 17f records the information (for example, the power amount or the electricity price) about the energy loss produced due to the dead band avoidance, and requests, to the electricity price managing server 20, the compensation of a price equivalent to the energy loss, at the accounting time of the electricity price.

The electricity price managing server 20 manages the information about the compensation of the price equivalent to the energy loss that has been requested from the EMS server 17f.

Here, the compensation may be performed not only by money, but also by discounting the electricity price at a timing when the dead band avoidance operation is not being performed, by allowing for a power selling at a higher price than usual, or the like.

Further, when the stock of the active power, for avoiding the dead band, is exchanged with a storage battery included in another adjacent local grid, the corresponding energy amount may be accounted separately from the usual accounting of the electricity price.

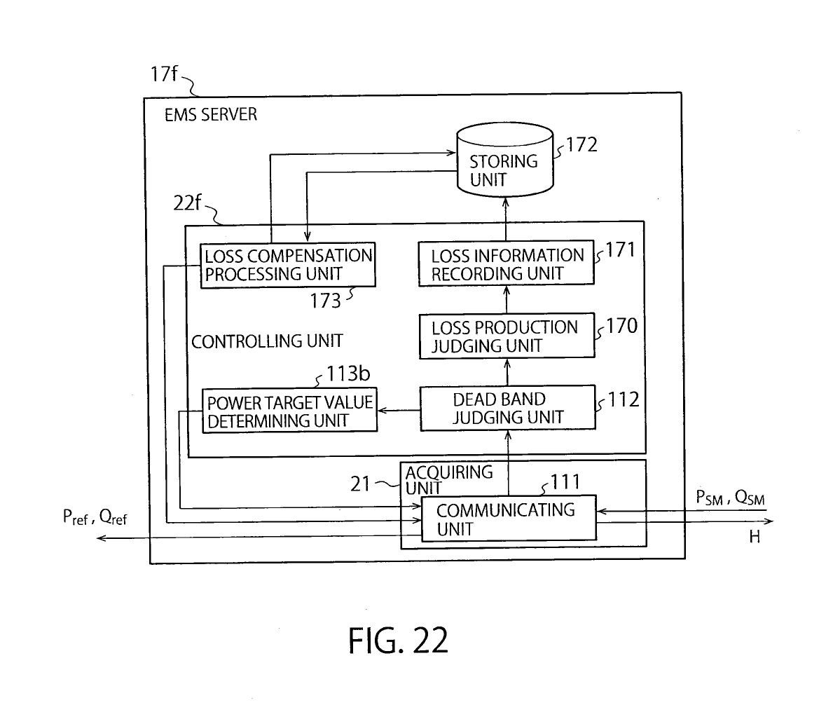

FIG. 22 is a diagram showing the configuration of the EMS server 17f according to the sixth embodiment. Relative to the configuration of the EMS server 17 (see FIG. 12) according to the second embodiment, in the configuration of the EMS server 17f according to the sixth embodiment, a storing unit 172 is added, and the controlling unit 22b is altered into a controlling unit 22f. Relative to the configuration of the controlling unit 22b (see FIG. 12) according to the second embodiment, in the configuration of the controlling unit 22f, a loss production judging unit 170, a loss information recording unit 171 and a loss compensation processing unit 173 are added. Here, for elements in common with FIG. 12, the same reference characters are assigned, and the concrete explanations are omitted.

In the case where the dead band judging unit 112 makes the judgment of being within the set range, the power target value determining unit 113 performs the process of altering the target value of the active power and/or the target value of the reactive power, and after this process, sends the target value of the active power and the target value of the reactive power from the communicating unit 111 to the power converting apparatus 11b. Further, in the case where the dead band judging unit 112 makes the judgment of being the set range, the acquiring unit 21 acquires, from the wattmeter 15b, the combination of the measured values of the active powers at a plurality of times. This is performed for calculating the power amount or electricity price lost due to the alteration of the target value by the power target value determining unit 113.

Then, the loss production judging unit 170 judges whether the loss has been produced due to the dead band avoidance control, based on the combination of the measured values of the active powers at the plurality of times that has been acquired by the acquiring unit 21.

In the case where the loss production judging unit 170 judges that the loss has been produced, the loss information recording unit 171 records the loss information (for example, the power amount or the electricity price) about the loss, in the storing unit 172. Thereby, the loss information is preserved in the storing unit 172.

The loss compensation processing unit 173 executes the loss compensation process, based on the loss information stored in the storing unit 172. For example, the loss compensation processing unit 173 requests the compensation of the price equivalent to the loss, to the electricity price managing server 20 through the communicating unit 111.

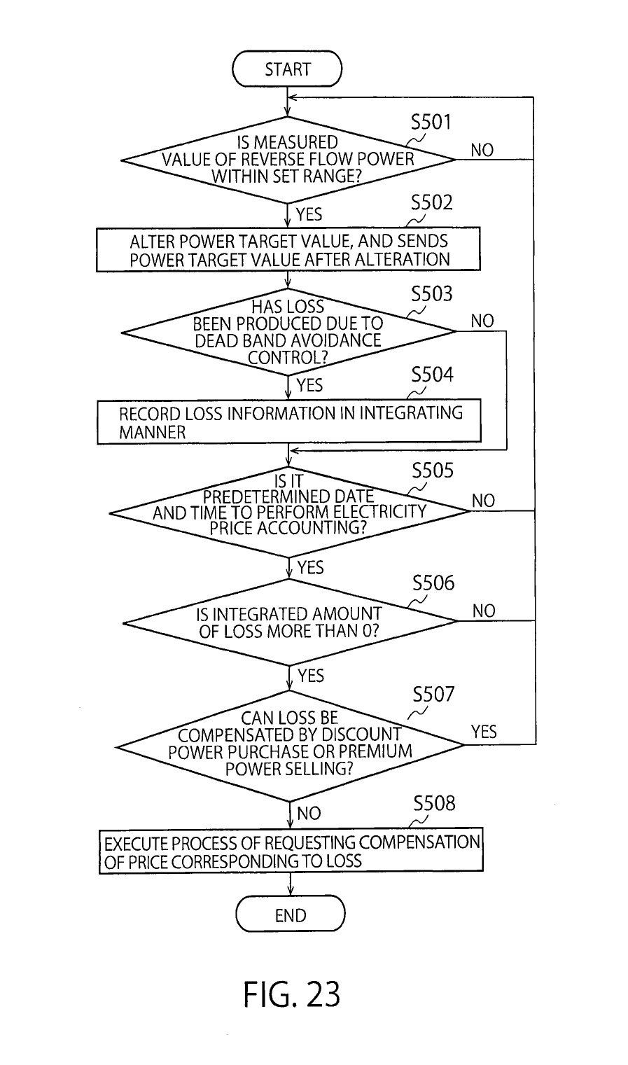

Next, the compensation process according to the sixth embodiment will be described using FIG. 23. FIG. 23 is a flowchart showing a compensation process example according to the sixth embodiment.

(Step S501) First, the dead band judging unit 112 judges whether the measured value of the reverse flow power is within the set range. In the case where the measured value of the reverse flow power is not within the set range, the waiting is performed with no change.
(Step S502) In the case where the measured value of the reverse flow power is within the set range in step S501, the power target value determining unit 113 alters the power target value, and makes the communicating unit 111 send the power target value after the alteration, to the power converting apparatus 11b.
(Step S503) Next, the loss production judging unit 170 judges whether the loss has been produced due to the dead band avoidance control, based on the combination of the measured values of the active powers at the plurality of times that has been acquired by the acquiring unit 21.
(Step S504) In the case of judging that the loss has been produced due to the dead band avoidance control in step S503, the loss information (for example, the power amount or the electricity price) about the loss is recorded in the storing unit 172, in an integrating manner.
(Step S505) In the case where the process in step S504 is completed, or in the case of judging that the loss has not been produced due to the dead band avoidance control in step S503, the loss compensation processing unit 173 judges whether the current date and time is a predetermined date and time to perform the electricity price accounting. In the case where the current date and time is not the predetermined date and time to perform the electricity price accounting, the EMS server 17f returns to the process in step S501.
(Step S506) In the case of judging that the current date and time is the predetermined date and time to perform the electricity price accounting in step S505, the loss compensation processing unit 173 judges whether the integrated amount of the loss is more than 0. In the case where the integrated amount of the loss is not more than 0, the EMS server 17f returns the process to step S501.
(Step S507) In the case of judging that the integrated amount of the loss is more than 0 in step S506, the loss compensation processing unit 173 judges whether the loss can be compensated by a discount power purchase or a premium power selling. In the case where the loss can be compensated by the discount power purchase or the premium power selling, the EMS server 17f returns the process to step S501.
(Step S508) In the case of judging that the loss cannot be compensated by the discount power purchase or the premium power selling in step S507, the loss compensation processing unit 173 requests the compensation of a price corresponding to the loss, to the electricity price managing server 20 through the communicating unit 111.

Thus, in the power converting system S6 according to the embodiment, in the case where the dead band judging unit 112 makes the judgment of being within the set range, the loss production judging unit 170 judges whether the loss has been produced due to the dead band avoidance control. In the case where the loss production judging unit 170 judges that the loss has been produced, the loss information recording unit 171 records the loss information (for example, the power amount or the electricity price) about the loss, in the storing unit 172. Then, the loss compensation processing unit 173 executes the loss compensation process, based on the loss information stored in the storing unit 172.

Thereby, a power company can take measures to compensate the loss produced due to the dead band avoidance control, and therefore, a customer is not disadvantaged. Further, since the falling within the dead band can be avoided, the power company can expect that the power converting apparatus on the customer side detects the isolated operation certainly and quickly.

Although the above-described process is performed by the EMS server as an example, the above-described process may be performed by the wattmeter. Concretely, instead of the EMS server, the wattmeter may include the loss production judging unit 170, the loss information recording unit 171, the storing unit 172 and the loss compensation processing unit 173.

### Seventh Embodiment

### About Feed-Back Control

Next, a seventh embodiment will be described. A power converting system according to the seventh embodiment controls the output power of the local grid such that it does not fall within the dead band, by a feed-back control.

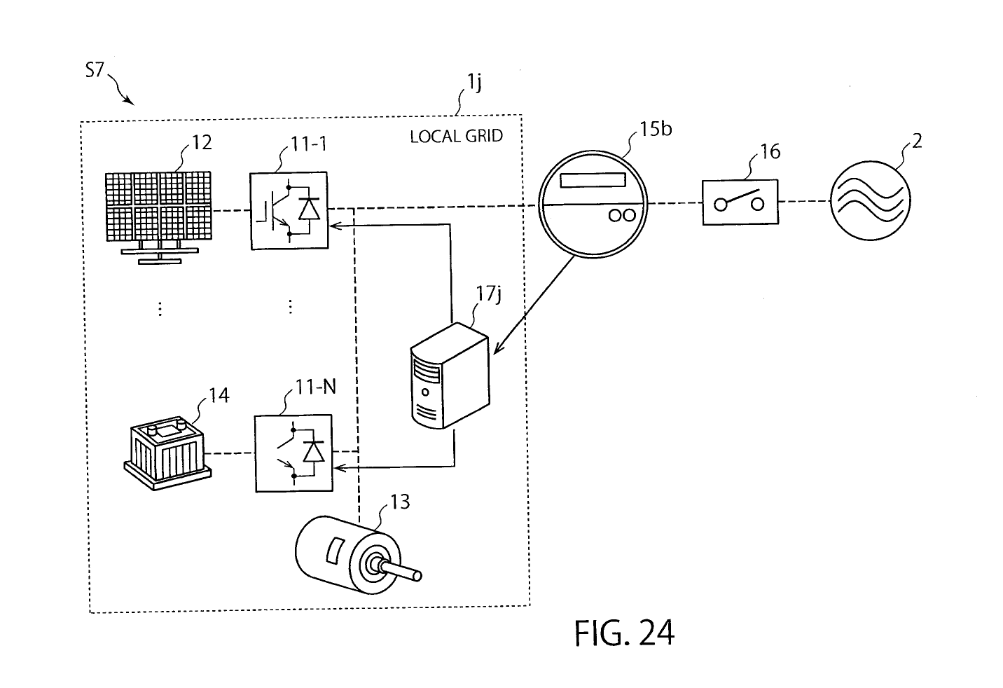

FIG. 24 is a diagram showing the configuration of a power converting system S7 according to the seventh embodiment. Compared to the power converting system S2 (see FIG. 10) according to the second embodiment, the power converting system S7 according to the seventh embodiment has a configuration in which a storage battery 14 is added, the EMS server 17 is altered into an EMS server 17j, and a plurality of power converting apparatuses, that is, power converting apparatuses 11-1, . . . , 11-N are included. Here, for elements in common with FIG. 10, the same reference characters are assigned, and the concrete explanations are omitted.

The EMS server 17j performs the feed-back control of the power converting apparatuses 11-1, . . . , 11-N in a local grid 1j, such that they have an active power control target value “P_{EMSref}” of the reverse flow power from the local grid 1j and a reactive power control target value “Q_{EmSref}” of the above reverse flow power, using the power value measured by the wattmeter 15b.

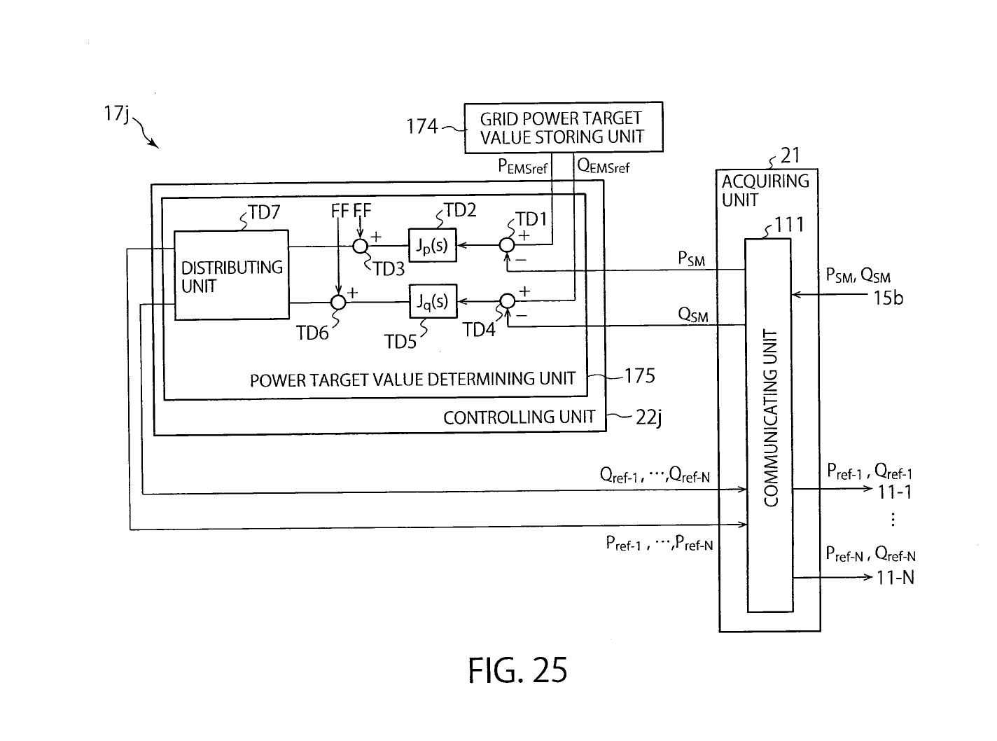

FIG. 25 is a diagram showing the configuration of the EMS server 17j according to the seventh embodiment. The EMS server 17j includes the acquiring unit 21, a grid power target value storing unit 174, and a controlling unit 22j.

Here, the acquiring unit 21 includes the communicating unit 111, and the controlling unit 22j includes a power target value determining unit 175.

The communicating unit 111 acquires, by communication, the measured value “P_{SM}” of the active power and the measured value “Q_{SM}” of the reactive power, from the wattmeter 15b, and outputs the measured value “P_{SM}” of the active power and the measured value “Q_{SM}” of the reactive power that have been acquired, to the power target value determining unit 175.

In the grid power target value storing unit 174, the active power control target value “P_{EMSref}” output from the local grid 1j, and the reactive power control target value “Q_{EMSref}” output from the local grid 1j are stored. Since it can be said that “P_{SM}” and “Q_{SM}” are away from the dead band unless being close to 0, the combination of the active power control target value and the reactive power control target value may be set as, for example, “P_{EMSref}”=10 kW, “Q_{EMSref}”=0 kW, or “P_{EMSref}”=0 kW, “Q_{EMSref}”=0.5 kW, or the like. Thereby, it is possible to perform the control for avoiding the dead band.

Whenever the acquiring unit 21 acquires the reverse flow power value, the power target value determining unit 175 determines the target value of the output power of the power converting apparatus, based on the difference between the reverse power value acquired by the acquiring unit 21 and the reverse flow power control target value. In the embodiment, the local grid includes the plurality of power converting apparatuses. Therefore, more concretely, whenever the acquiring unit 21 acquires the reverse flow power value, the power target value determining unit 175 determines the target values of the output powers of the respective power converting apparatuses, based on the difference between the reverse flow power value acquired by the acquiring unit 21 and the reverse flow power control target value. Here, the reverse flow power value is the measured value of the active power and/or the measured value of the reactive power for the reverse flow power.

Concretely, the power target value determining unit 175 executes at least one of the determination of the target value of the output active power for the power converting apparatus based on the difference between the measured value of the active power acquired by the acquiring unit 21 and the active power control target value of the reverse flow power, and the determination of the target value of the output reactive power for the power converting apparatus based on the difference between the measured value of the reactive power acquired by the acquiring unit 21 and the reactive power control target value of the reverse flow power. In the embodiment, as an example, the power target value determining unit 175 executes both of the above.

More concretely, the power target value determining unit 175 reads, from the grid power target value storing unit 174, the active power control target value “P_{EMSref}” output from the local grid 1j, and the reactive power control target value “Q_{EMSref}” output from the local grid 1j. Then, the power target value determining unit 175 determines the target values “P_{ref-1}”, . . . , “P_{ref-N}” of the output active power of the respective power converting apparatuses 11-i (“i” is an integer of 1 to N), based on the difference between the measured value “P_{SM}” of the active power and the active power control target value “P_{EMSref}”. Similarly, the power target value determining unit 175 determines the target values “Q_{ref-1}^{”}, . . . , “Q_{ref-N}” of the output reactive powers of the respective power converting apparatuses 11-i (“i” is an integer of 1 to N), based on the difference between the measured value “Q_{SM}” of the reactive power and the reactive power control target value “Q_{EMSref}”.

The power target value determining unit 175 outputs, to the communicating unit 111, the respective combinations of the target values “P_{ref-i}” of the output active powers and the target values “Q_{ref-i}” of the output reactive powers that have been determined.

The communicating unit 111 sends the respective target values of the output powers of the power converting apparatuses 11-i that have been determined by the power target value determining unit 175, that is, the respective combinations of the target values “P_{ref-i}” of the active powers and the target values “Q_{ref-i}” of the reactive powers, to the corresponding power converting apparatuses 11-i. Thereby, notices about the target values “P_{ref-i}” of the active powers and the target values “Q_{ref-i}” of the reactive powers are given to the corresponding power converting apparatuses 11-i.

Here, the power target value determining unit 175 includes a subtracting unit TD1, a transfer function multiplying unit TD2, an adding unit TD3, a subtracting unit TD4, a transfer function multiplying unit TD5, an adding unit TD6 and a distributing unit TD7.

The subtracting unit TD1 subtracts the measured value “P_{SM}” of the active power input from the communicating unit 111, from the active power control target value “P_{EMSref}” read from the grid power target value storing unit 174, and outputs the value after the subtraction, to the transfer function multiplying unit TD2.

The transfer function multiplying unit TD2 multiplies the value input from the subtracting unit TD1, by a predetermined transfer function “Jₚ(s)”, and outputs the value obtained by the multiplication, to the adding unit TD3. Here, “Jₚ(s)=K_{jqp}+K_{jqi}/s” holds. Here, “K_{jqp}” is a proportionality coefficient, and “K_{jqi}” is an integration coefficient.

The adding unit TD3 adds a feed-forward term “FF”, to the value input from the transfer function multiplying unit TD2. The value after the addition is the target value of the sum of the active powers of the power converting apparatuses. The adding unit TD3 outputs the target value of the sum of the active powers of the power converting apparatuses, to the distributing unit TD7.

When the impedance “Z” of the load 13 is already known, or can be predicted, it is found that the apparent power of the load 13 is “V²Z”, from the impedance “Z” and the voltage “V”. Therefore, the apparent power “V²Z” of the load 13 may be set as the feed-forward term “FF”. Thereby, it is possible to actualize a more stable control.

The subtracting unit TD4 subtracts the measured value “Q_{SM}” of the reactive power input from the communicating unit 111, from the reactive power control target value “Q_{EMSref}” read from the grid power target value storing unit 174, and outputs the value after the subtraction, to the transfer function multiplying unit TD5.

The transfer function multiplying unit TD5 multiplies the value input from the subtracting unit TD4, by a predetermined transfer function “J_{q}(s)”, and outputs the value obtained by the multiplication, to the adding unit TD6. “J_{q}(s)=K_{jqp}+K_{jqi}/s” holds. Here, “K_{jqp}” is a proportionality coefficient, and “K_{jqi}” is an integration coefficient.

The adding unit TD6 adds the feed-forward term “FF”, to the value input from the transfer function multiplying unit TD5. The value after the addition is the target value of the sum of the reactive powers of the power converting apparatuses. The adding unit TD6 outputs the target value of the sum of the reactive powers of the power converting apparatuses, to the distributing unit TD7. Here, as described above, the apparent power “V²Z” of the load 13 may be set as the feed-forward term “FF”.

In accordance with a predetermined regulation, the distributing unit TD7 determines the target values “P_{ref-1}”, . . . , “P_{ref-N}” of the active powers of the respective power converting apparatuses, from the target value of the sum of the active powers of the power converting apparatuses that has been input from the adding unit TD3. For example, the distributing unit TD7 divides the value input from the adding unit TD3 by “N”, and determines that the target values “P_{ref-i}”, “P_{ref-N}” of the active powers of the respective power converting apparatuses are the value divided by “N”. The distributing unit TD7 makes the communicating unit 111 send the determined target values “P_{ref-1}”, . . . , “P_{ref-N}” of the active powers of the respective power converting apparatuses, to the corresponding power converting apparatuses, respectively. Thereby, the notices about the target values “P_{ref-i}” of the active powers of the power converting apparatuses are given to the power converting apparatuses 11-i.

Further, in accordance with a predetermined regulation, the distributing unit TD7 determines the target values “Q_{ref-1}”, . . . , “Q_{ref-N}” of the reactive powers of the respective power converting apparatuses, from the target value of the sum of the reactive powers of the power converting apparatuses that has been input from the adding unit TD6. For example, the distributing unit TD7 divides the value input from the adding unit TD6 by “N”, and determines that the target values “Q_{ref-1}”, . . . , “Q_{ref-N}” of the reactive powers of the respective power converting apparatuses are the value divided by “N”. The distributing unit TD7 makes the communicating unit 111 send the determined target values “Q_{ref-1}”, . . . , “Q_{ref-N}” of the reactive powers of the respective power converting apparatuses, to the corresponding power converting apparatuses, respectively. Thereby, the notices about the target values “Q_{ref-i}” of the reactive powers of the power converting apparatuses are given to the power converting apparatuses 11-i.

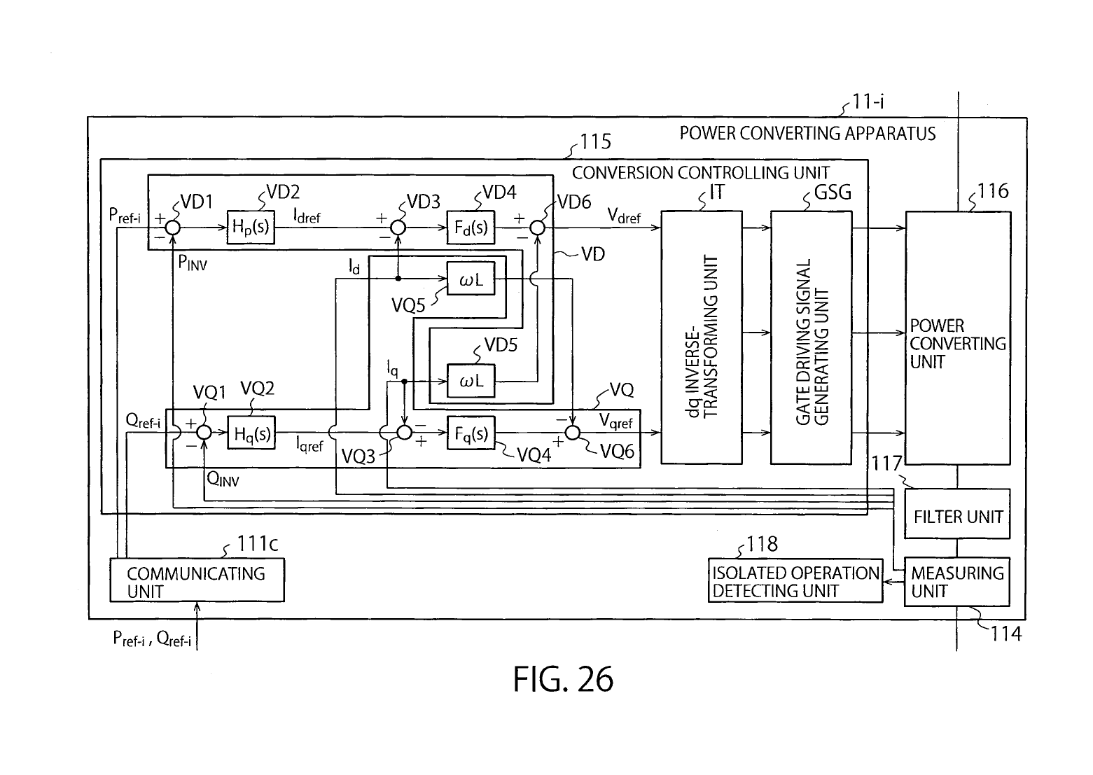

FIG. 26 is a diagram showing the configuration of the power converting apparatus 11-i according to the seventh embodiment. Relative to the configuration of the power converting apparatus 11b (see FIG. 13) according to the second embodiment, in the configuration of the power converting apparatus 11-i according to the seventh embodiment, the communicating unit 111b is altered into a communicating unit 111c. Here, for elements in common with FIG. 13, the same reference characters are assigned, and the concrete explanations are omitted.

The communicating unit 111c receives the target value “P_{ref-i}” of the active power of the power converting apparatus and the target value “Q_{ref-i}” of the reactive power of the power converting apparatus that have been sent by the EMS server 17j, and outputs the received information to the conversion controlling unit 115.

Here, in the embodiment, as an example, the EMS server 17j performs such a control that the active power value and reactive power value for the reverse flow power of the local grid 1 are the target value, but may performs such a control that only either of the active power value and reactive power value for the reverse flow power of the local grid 1 is the target value.

Also by this, since one of the active power and reactive power for the reverse flow power of the local grid 1 does not get to be 0, it is possible to prevent the reverse flow power of the local grid 1 from failing within the dead band. That is, the EMS server 17j may perform such a control that at least one of the active power value and reactive power value for the reverse flow power of the local grid 1 is the target value.

Further, for example, when the EMS server 17j performs such a control that the reactive power for the reverse flow power of the local grid 1 is the target value, the power target value determining unit 175 may determine the target value of the sum of the reactive powers for the reverse flow power, based on the difference between the measured value of the reactive power acquired by the acquiring unit 21 and the target value of the reactive power for the reverse flow power. Then, the power target value determining unit 175 may determine the target values of the reactive powers to be output by the respective power converting apparatuses 11-i, based on the determined target value of the sum of the reactive powers for the reverse flow power.

To summarize the above, in the seventh embodiment, whenever the acquiring unit 21 acquires the reverse flow power value, the power target value determining unit 175 determines the target value of the power to be output by the power converting apparatus, based on the difference between the reverse flow power value acquired by the acquiring unit 21 and the target value of the reverse flow power. Thereby, the control is performed such that the reverse flow power value of the local grid 1 is converged on the target value of the reverse flow power, and therefore, it is possible to constantly avoid the reverse flow power value of the local grid 1 from falling within the dead band.

Here, as for the active power control target value “P_{EMSref}” and the reactive power control target value “Q_{EMSref}”, the values are fixed, but is not limited to this. The EMS server 17j may further include a grid power target determining unit, and the grid power target determining unit may determine the active power control target value “P_{EMSref}” and the reactive power control target value “Q_{EMSref}”, by computation. In addition, the active power control target value “P_{EMSref}” and the reactive power control target value “Q_{EMSref}” may be acquired from a further superordinate system by communication, or may be values that the power converting apparatus 11-i determines by computation, or the like.

Here, in the embodiment, the control to be performed by the EMS server 17j may be performed by the power converting apparatus or the wattmeter.

### (Control of a Plurality of Power Converting Apparatuses)

When a plurality of power converting apparatuses or loads whose outputs can be altered by communication are present in the local grid, these apparatuses may perform the output while performing the coordinate control with each other or with the wattmeter, by communication. As necessary, an apparatus called an EMS server or a controller may join in the communication.

The control may be performed in an autonomous disturbed manner. However, the coordinate control under a master apparatus that is an entity of the control makes the whole control easier. When an apparatus such as the EMS server or the controller is present, it is preferable that the apparatus be the master apparatus. However, a mode in which one of a plurality of power converting apparatuses, loads and wattmeters performs the control as the master apparatus is also allowable.

The apparatus called the master apparatus here is the entity to determine the output of the control. A role as the entity of the communication system, a role in performing the communication interconnection with a superordinate system, a role as the entity of the time synchronization or the output synchronization among the apparatuses, and the like may be taken by different apparatuses, respectively.

Further, the role sharing for the master apparatus and others may be fixed, but preferably, should be flexibly alterable by using communication, in consideration of the handling at the time of failure. In the case of a system in which the roles of the master and the like can be altered among the plurality of apparatuses, the information about the apparatuses such as type information, the working situation and error information, the physical position information, the position information on the communication network, and the position information on the power network may be exchanged by communication, and a predetermined algorithm adopting them as parameters may select the optimum apparatus as the master apparatus.

Here, for example, when the wiring of the communicating apparatuses is provided in a star shape, it seems that a higher communication throughput is given by adopting a central apparatus in the wire connection or an apparatus close to the center as the master apparatus, and therefore, the consideration of the position information on the communication network means to adopt such an apparatus as a candidate of the master apparatus. Meanwhile, for example, an apparatus installed at an interconnecting point can obtain the measured power value at the interconnecting point more quickly and certainly, allowing for a speedy judgment of the dead band, and therefore, the consideration of the position information on the power network means to adopt such an apparatus as a candidate of the master apparatus.

In the case of using a wireless communication, it can be said that an apparatus whose physical installed position is closer to the center of the local grid is likely to be able to certainly communicate with more apparatuses, and therefore, an apparatus whose physical installed position is within a predetermined range from the center of the local grid may be adopted as a candidate of the master apparatus. Further, it can be said that an apparatus with a lower communication error rate is likely to be able to communicate more certainly, and therefore, an apparatus in which the communication error rate is less than a predetermined threshold value may be adopted as a candidate of the master apparatus.

### Eighth Embodiment

### About Offsetting of Reactive Power

Next, an eighth embodiment will be described. As described above, the effect of the avoidance of the dead band can be expected by the transfer of the reactive power with the grid. However, the increase in the reactive power amount, which causes the disturbance of the grid, is undesirable. Hence, in a controlling system to control a power converting system according to the eighth embodiment, the EMS server of the local grid interconnects with an EMS server of another local grid by communication, and offsets the reactive powers to be output from the two local grids.

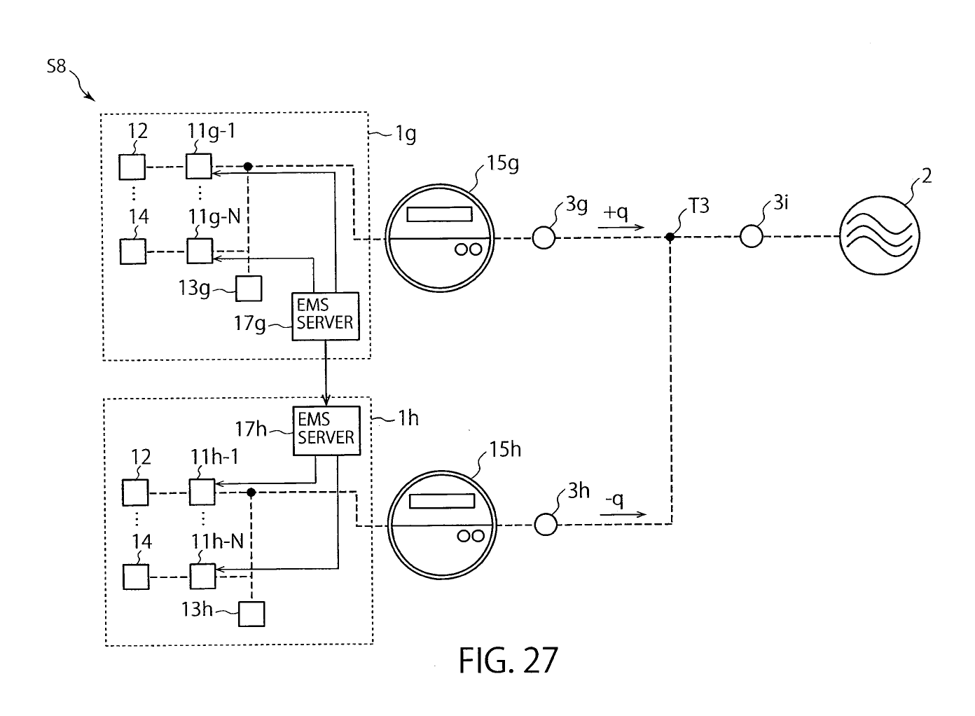

FIG. 27 is a diagram showing the configuration of a power converting system S8 according to the eighth embodiment. As shown in FIG. 27, a power line to transmit the output power of a local grid 1g and a power line to transmit the output power of a local grid 1h are electrically connected at a connecting point T3, and the connecting point T3 is connected with a power system. The local grid 1g includes power converting apparatuses 11g-1, . . . , 11g-N to output the alternating-current power to the power system 2, a load 13g, and an EMS server 17g. The local grid 1h includes power converting apparatuses 11h-1, . . . , 11h-N to output the alternating-current power to the power system 2, a load 13h, and an EMS server 17h.

A wattmeter 15g measures the active power and reactive power output from the local grid 1g.

A wattmeter 15h measures the active power and reactive power output from the local grid 1h.

Next, the outline of the operation of the power converting system S8 will be described. For example, the EMS server 17g controls the power converting apparatuses 11g-1, . . . , 11g-N such that the reactive power control target value “Q_{EMSref-g}” of the local grid 1g is “+q”. The EMS server 17g notifies, by communication, the EMS server 17h of “−q”, as the reactive power control target value “Q_{EMSref-h}” of the local grid 1h. Thereby, the EMS server 17h controls the power converting apparatuses 11h-1, . . . , 11h-N such that the reactive power to be output from the local grid 1h is “−q”.

Thereby, the reactive power “+q” transmitted from the local grid 1g and the reactive power “−q” transmitted from the local grid 1h are offset. Therefore, it is possible to avoid the dead band at an interconnecting point 3g, and thereby, the isolated operation detecting unit 118 of the power converting apparatus 11g can detect the isolated operation accurately and quickly. Therewith, it is possible to suppress the disturbance to the power system 2.

Here, the configurations of the power converting apparatus 11g-i and the power converting apparatus 11h-i are the same as the power converting apparatus 11-i (see FIG. 26) according to the seventh embodiment, and therefore, the explanations are omitted.

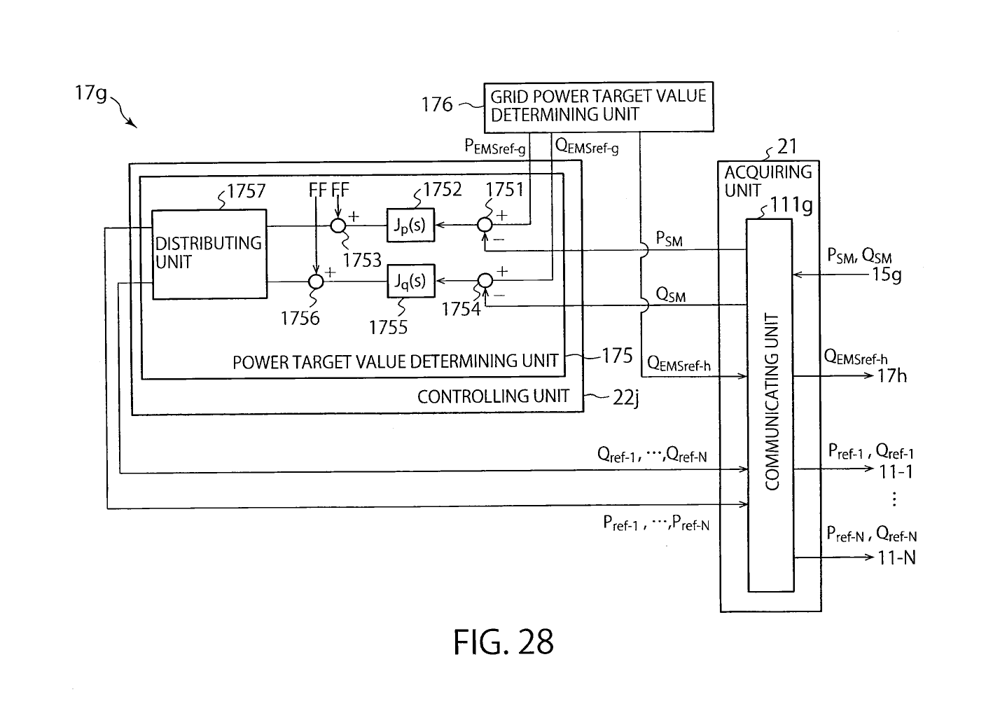

FIG. 28 is a diagram showing the configuration of the EMS server 17g according to the eighth embodiment. Compared to the configuration of the EMS server 17j according to the seventh embodiment, in the EMS server 17g according to the eighth embodiment, the grid power target value storing unit 174 is removed, a grid power target value determining unit 176 is added, and the communicating unit 111 is altered into a communicating unit 111g.

The grid power target value determining unit 176 determines the reactive power control target value “Q_{EMSref-g}” of the local grid 1g and the reactive power control target value “Q_{EMSref-h}” of the local grid 1h, such that the reactive power output from the local grid 1g is offset. In the embodiment, as an example, it determines that the reactive power control target value “Q_{EMSref-q}” of the local grid 1g is “+q”, and determines that the reactive power control target value “Q_{EMSref-h}” of the local grid 1h is “−q”. Then, the grid power target value determining unit 176 makes the communicating unit 111g send the determined reactive power control target value “Q_{EMSref-h}” of the local grid 1h, to the EMS server 17h.

Further, for example, the grid power target value determining unit 176 outputs a previously determined active power control target value “P_{EMSref-g}” of the local grid 1g and the determined reactive power control target value “Q_{EMSref-q}” of the local grid 1g, to the power target value determining unit 175.

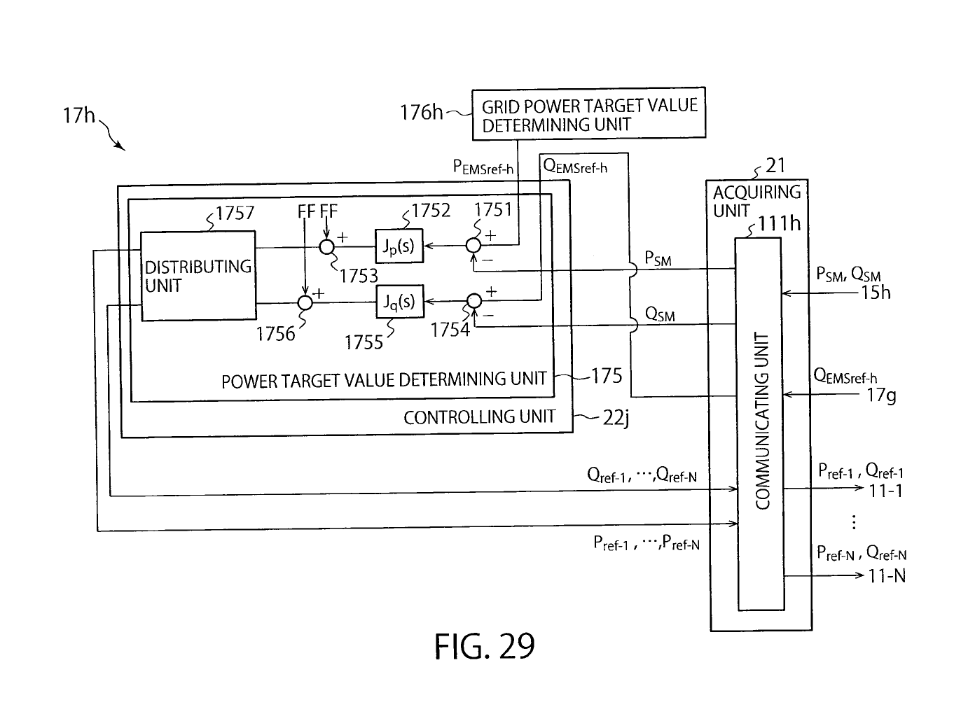

FIG. 29 is a diagram showing the configuration of the EMS server 17h according to the eighth embodiment. Compared to the configuration of the EMS server 17j according to the seventh embodiment, in the EMS server 17h according to the eighth embodiment, the grid power target value storing unit 174 is removed, a grid power target value determining unit 176h is added, and the communicating unit 111 is altered into a communicating unit 111h.

The communicating unit 111h receives the reactive power control target value “Q_{EMSref-h}” sent by the EMS server 17, and outputs the received reactive power control target value “Q_{EMSref-h}” to the power target value determining unit 175.

For example, the grid power target value determining unit 176h outputs a previously determined active power control target value“P_{EMSref-g}” of the local grid 1g, to the power target value determining unit 175.

As shown in FIG. 27, the offsetting of the reactive power is performed closer to the power system side than the interconnecting point 3g or 3i where the parallel-off is assumed. Thereby, it is possible to prevent the dead band at the interconnecting point 3g or 3i where the parallel-off is assumed. Therefore, it is possible to easily detect the isolated operation at the interconnecting point 3g or 3i where the parallel-off is assumed, while zeroing the reactive power to be supplied to the power system.

Here, the number of local grids is two in the embodiment, but without being limited to this, may be three or more. In that case, one EMS server of the EMS servers respectively included in the plurality of local grids may be set as a master EMS, and by communication, the master EMS may notify the other EMS servers of the target values of the reactive powers to be output from the local grids that are included in the respective EMS servers. Alternatively, by communication, a superordinate server to control all the EMS servers may notify the EMS servers of the target values of the reactive powers to be output from the local grids that are included in the respective EMS servers. Thereby, it is possible to offset the reactive power, even when the output powers from the three or more local grids are superimposed and are output to the power system.

In the embodiment, the offsetting of the reactive power has been described. However, the offsetting of the active power may be performed. Thereby, it is possible to suppress a rapid power fluctuation.

Further, in the embodiment, the offsetting of the reactive power and/or active power has been described. However, the reactive power and/or active power to be supplied to the power system may be kept within a predetermined range without completely offsetting the reactive power. Therefore, the grid power target value determining unit 176 may determine the target values of the reactive powers and/or the target values of the active powers of the respective local grids, such that the sum of the reactive power and/or the sum of the active power to be output from the respective local grids are kept within a predetermined range.

Thus, the control system according to the embodiment is a control system to control the power converting system S8 in which power lines to transmit the alternating-current powers output from a plurality of first grids, each of which includes a first power generating apparatus and the power converting apparatus to output the alternating-current power based on the power generated by the first power generating apparatus, are joined and are connected with a second grid including a second power generating apparatus. Here, each of the first grids includes one or more power converting units that output the alternating-current power to the second grid, based on the power generated by the first power generating apparatus.

The controlling system includes the grid power target value determining unit 176 to determine the target values of the reactive powers and/or the target values of the active powers to be output from the respective first grids, such that the sum of the reactive powers and/or the sum of the active powers to be output from the respective first grids are kept within the predetermined range. Further, the controlling system includes the plurality of controlling units 22j to control the alternating-current powers that are output by the power converting units included in the corresponding first grids, based on the target values of the reactive powers and/or the target values of the active powers determined by the grid power target value determining unit 176. Here, in the embodiment, the first grid is a local grid as an example, and the second grid is a power system as an example.

Thereby, it is possible to suppress the fluctuation in the active power to be supplied to the power system 2 or the fluctuation in the reactive power, while avoiding the output power from the local grid, from falling within the dead band. Thereby, the isolated operation detecting unit 118 of the power converting apparatus 11g can detect the isolated operation accurately and quickly, and therewith, it is possible to suppress the disturbance to the power system 2.

Needless to say, the embodiment can be applied even when the reactive power or the active power is offset against a reactive power compensating apparatus, a power generating facility, a dispersion power source facility or the like, other than the different local grid in the surrounding.

Here, the EMS server 17g may communicate with a reactive power compensating apparatus (STATCOM: Static Synchronous Compensator), and may perform such a coordinate control that the reactive power to reversely flow to the grid is ±0.

Here, the communicating unit of the power converting apparatus may acquire the power outage information about the power outage at the current time and the instantaneous voltage drop information about the instantaneous voltage drop at the current time, from an external apparatus. Then, the isolated operation detecting unit 118 may refer to the power outage information and the instantaneous voltage drop information, for judging whether to be in the isolated operation state. Concretely, if the instantaneous voltage drop information shows that the instantaneous voltage drop is currently occurring, the isolated operation detecting unit 118 may make the judgment of being in the isolated operation state.

In the case where the power outage information or the instantaneous voltage drop information is the information that the power outage or the instantaneous voltage drop is currently occurring, respectively, the isolated operation detecting unit 118 may make the judgment of being in the isolated operation state, when receiving the power outage information or the instantaneous voltage drop information as a trigger. This is because it can be regarded that the parallel-off from the power system has been performed due to the power outage or the instantaneous voltage drop.

Further, the isolated operation detecting unit 118 may start the active detection of the isolated operation, when receiving the power outage information or the instantaneous voltage drop information as a trigger. Then, for example, when the reactive power is injected and the voltage decreases by a predetermined amount or more, the judgment of being in the isolated operation state may be made, because it can be regarded that the parallel-off has been performed due to the power outage or the instantaneous voltage drop. Thereby, it is possible to detect the isolated operation state quickly and certainly.

### Application Example

In the following, application examples of the above-described embodiments described above will be described.

### Application Example 1

### Micro Grid

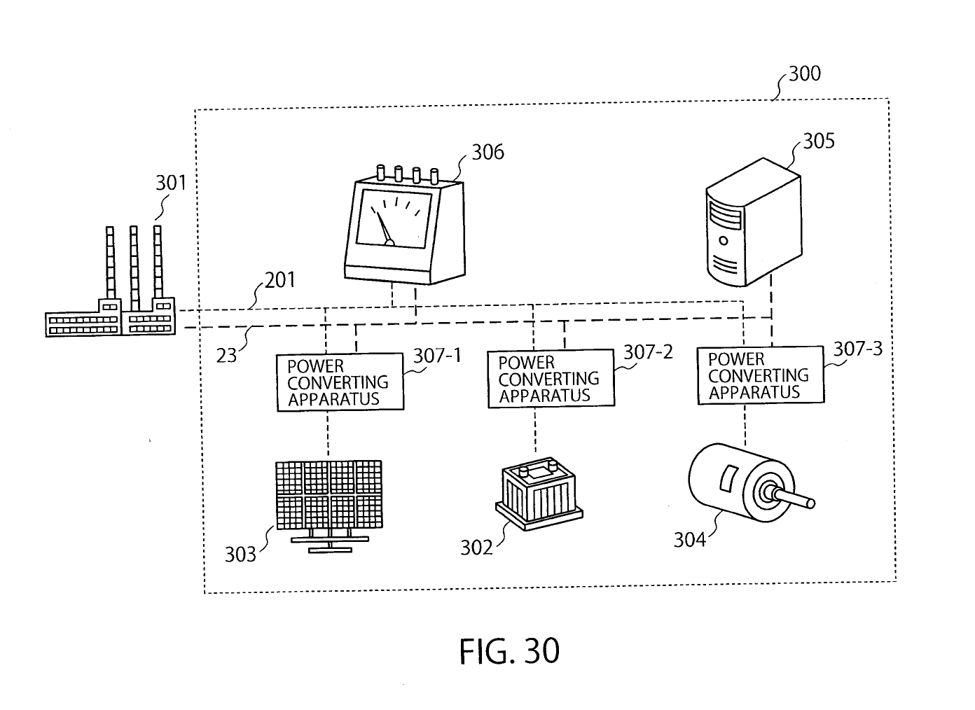

FIG. 30 is a first application example of the configuration of a power converting system according to the embodiments. As one application example of the power converting system, a micro grid is possible. Concretely, a small or middle scale power system in a general household, a store, a factory, a building, a station, a commercial facility, or the like is possible. Generally, a unit such as one block in a city or a whole city is not called a micro grid. However, since the constituent elements of the system are common, a large scale grid system is also included in this discussion. Hereinafter, the micro grid is referred to as the local grid also. As an example, a local grid 300 includes a power generating apparatus 303, a power storing apparatus 302, a load 304, a power line 201 that joins them with power converting apparatuses 307, an information communicating line 23 and the like, as basic elements.

FIG. 30 shows an example in which there are three power converting apparatuses (307-1, 307-2, 307-3), as an example. Here, the number of power converting apparatuses may be two or less, or may be four or more. Thus, the power converting system according to the embodiments includes at least a plurality of power converting apparatuses.

In addition, various sensors 306, an EMS (Energy Management System) server 305, other apparatuses relevant to power, and the like may be present. Each constituent element includes a communication feature, and therefore, an advanced control of the whole system and a coordination with an external system are possible.

In FIG. 30, as an example, the local grid 300 is connected with a power system 301 through the power line 201, and can receive the power supply from the power system 301. Further, when surplus power is generated in the local grid 300, it is possible to reversely transmit the power (reverse power flow). Also, it is possible to simultaneously consume the power produced in the local grid 300 and the power supplied from the power system 301. Further, the local grid may include another local grid as an internal element or an adjacent element, and may be independent of the power system. Further, a case in which the local grid is interconnected with a single or a plurality of power systems through two or more paths is also possible.

In some cases, as constituent elements of the local grid 300, a power converting apparatus to which the embodiments are not applied, a load that is not sufficiently controlled by a controller because of having no communication feature, and the like are mixed, in addition to the power converting apparatuses to which the embodiments have been applied, a wattmeter and the controller. Also in such cases, it is possible to obtain the benefit of the embodiments.

### Application Example 2

### Dispersion Power Source

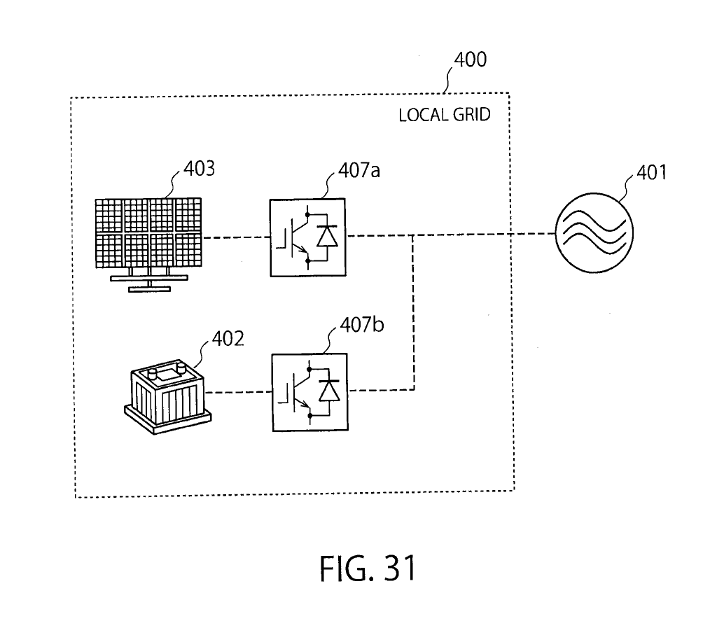

Application examples of the embodiments include an application and use for a power converting system that includes a plurality of grid interconnecting inverters and operates them. FIG. 31 is a second application example of a power converting system according to the embodiments. To a power system 401, a variety of small to large scale power generating apparatuses 403 and power storing apparatuses 402 are connected through power converting apparatus 407a or 407b. The power converting apparatuses 407a and 407b are grid interconnecting inverters. In many cases, a special load or the like is not provided between the grid interconnecting inverters and the power system. However, in the case of concurrently using a storage battery, the storage battery during charge can be regarded as a load that is consuming power, from a viewpoint of the power converting system. In addition, a sensor such as a wattmeter is used. The local grid 400 is managed by a small to large scale EMS, power company, aggregator or others. The grid interconnecting inverter, which is an inverter to supply power to a grid as an alternating current power output, is installed particularly in mega solar stations, small or middle scale power stations or power storing facilities, or the like, and besides these, is installed in a great variety of palaces such as a household, a building, facilities such as a factory, or a micro grid, to be utilized. The output voltage has a great range, for example, a single-phase voltage of 100 V, and a three-phase voltage of 200 V, including a direct-current system. The output is controlled in accordance with the voltage and frequency of the power system 401, and the transfer of the power is performed. Further, a grid interconnecting system having a storage battery use and the like support both the forward power flow and the reverse power flow. In such a system, each apparatus can have a communication feature, and transfers various sorts of data such as power data, using communications.

### Application Example 3

### Railway, Elevating Machine, Industrial Use

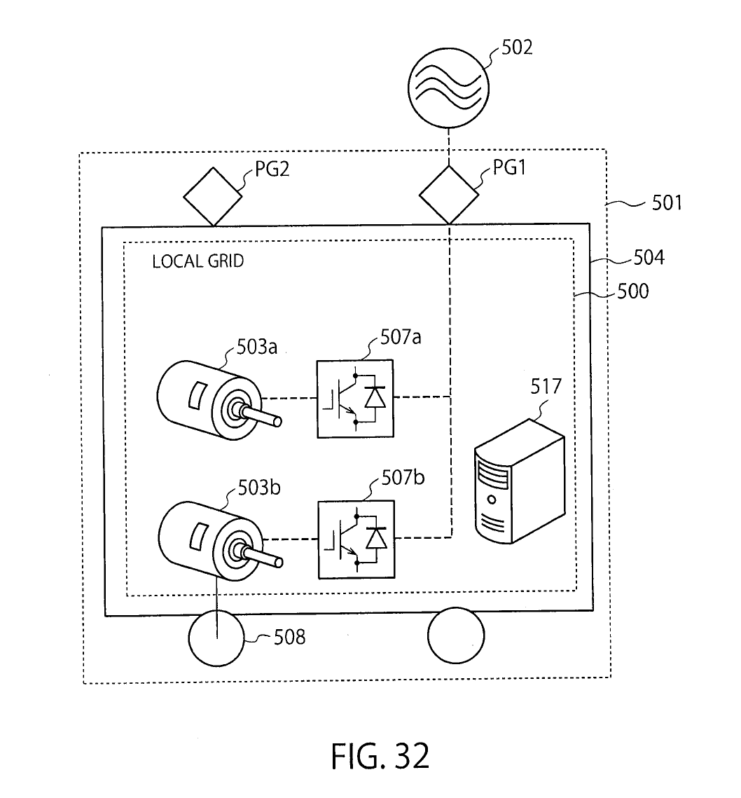

In a power converting apparatuses according to the embodiment, the application to a system for a railway vehicle, an elevating machine, a FA or the like is also possible. In such a system, a plurality of inverters, motors, sensors or others are used in an autonomous coordination manner or under the control by a controller, while performing communications. FIG. 32 shows an example of a railway vehicle system.

FIG. 32 is a third application example of a power converting system according to the embodiments. One car or one set of a railway vehicle can be also regarded as a kind of local grid. In the example of FIG. 32, a railway vehicle 501 consisting of one car is a local grid 500. The railway vehicle 501 includes two pantographs PG1 and PG2, a vehicle body 504 and a wheel 508, and is connected with a power system 502 through the pantograph PG1. In the railway vehicle 501, there are a load 503a such as air conditioning equipment to operate by a motor, a power converting apparatus 507a, a load 503b as a motor to drive the wheel 508, a power converting apparatus 507b, and other loads such as lights not shown in the figure. These loads are managed under the controller, and this is illustrated as an EMS server 517 (in the railway vehicle system).

In many cases, a regenerative brake is utilized in a railway vehicle, and during regeneration, the load 503b operates as a power generator. The regeneration energy is originally the kinetic energy of a vehicle body into which the electric energy obtained from the power system 502 is converted, and therefore, in a broad sense, it can be interpreted that the vehicle itself is a power storing apparatus, and the load 503b as the wheel driving motor is a power converting apparatus. An apparatus such as an elevator and an escalator is different from the railway vehicle in the relation between stationary apparatuses and moving apparatuses, but, similarly to the railway vehicle from the standpoint of the power converting system, can be regarded as a local grid that is configured by a load, a power storing apparatus, a power generating apparatus, a power converting apparatus, a sensor, a controller and others. Further, in the railway system, there is a feeder section between sections whose electric modes are different between before and after the feeder section. Since the feeder section is a section where electricity does not flow, the local grid is temporarily paralleled off from the power system while the railway vehicle are passing through this section, and is interconnected again after it passes through the feeder section.

Here, it is allowable that a program for executing the processes of the power converting apparatus or EMS server according to the embodiments is recorded in a computer-readable recording medium, a computer system reads the program recorded in the recording medium, and the processor executes it so that the above various processes associated with the power converting apparatus or EMS server according to the embodiments are performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A controlling apparatus comprising:
an acquiring unit that acquires a power value of a power line, the power line transmitting power between a first grid and a second grid, the first grid including a first power generating apparatus and a power converting apparatus that outputs an alternating-current power based on a power generated by the first power generating apparatus, the second grid including a second power generating apparatus; and
a controlling unit that controls the alternating-current power to be output by the power converting apparatus such that the power value does not fall within a dead band.

2. The controlling apparatus according to claim 1,
wherein the acquiring unit acquires, as the power value, a measured value of an active power and a measured value of a reactive power from a wattmeter by communication, and
the controlling unit comprises:
a dead band judging unit that judges whether a combination of the measured value of the active power and the measured value of the reactive power acquired by the acquiring unit is within a set range, the set range being previously set; and
a power target value determining unit that determines a target value of the alternating-current power to be output by the power converting apparatus, in a case where the dead band judging unit makes a judgment of being within the set range, the target value being used when the power converting apparatus controls the output power.

3. The controlling apparatus according to claim 2,
wherein the power target value determining unit alters at least one of a target value of the active power and a target value of the reactive power for the alternating-current power to be output by the power converting apparatus.

4. The controlling apparatus according to claim 2,
wherein the power target value determining unit calculates a value of an evaluation function, and determines the target value of the alternating-current power to be output by the power converting apparatus, depending on the calculated value of the evaluation function, the evaluation function evaluating how close the combination of the measured value of the active power and the measured value of the reactive power acquired by the acquiring unit is to the dead band.

5. The controlling apparatus according to claim 1,
wherein the first grid includes a first power converting apparatus and a second converting apparatus, as the power converting apparatus, an output of the second power converting apparatus being connected with a power line that transmits an alternating-current power to be output by the first power converting apparatus,
the acquiring unit acquires a measured value of a first output power from a first wattmeter by communication, and acquires a measured value of a second output power from a second wattmeter by communication, the first output power being output to the second grid by the first power converting apparatus, the second output power being output to the second grid by the second power converting apparatus, and
the acquiring unit estimates a power value to be supplied to the second grid by the first grid, based on the measured value of the first output power and the measured value of the second output power.

6. The controlling apparatus according to claim 5,
wherein the acquiring unit estimates the power value at a predetermined time, based on the power values at a plurality of times.

7. The controlling apparatus according to claim 5,
wherein the acquiring unit estimates the first output power at a predetermined time, based on the first output powers at a plurality of times, and acquires a sum of the estimated first output power at the predetermined time and the second output power at the predetermined time, as the power value at the predetermined time.

8. The controlling apparatus according to claim 1,
wherein the first grid is connected with the second grid through a pole-mounted transformer,
the acquiring unit acquires a measured value of an active power and a measured value of a reactive power from the wattmeter by communication, and
the dead band judging unit judges whether a combination of the measured value of the active power acquired by the acquiring unit and a value resulting from subtracting a reactive power corresponding to an inductance of the pole-mounted transformer from the measured value of the reactive power is within a set range, the set range being previously set.

9. The controlling apparatus according to claim 2,
wherein the acquiring unit acquires a combination of measured values of the active powers at a plurality of times, in the case where the dead band judging unit makes the judgment of being within the set range, and
the controlling unit judges whether loss has been produced due to a dead band avoidance control, based on the combination of the measured values of the active powers at the plurality of times, and, in a case of judging that the loss has been produced, records loss information about the loss in astorage, to execute a loss compensation process based on the loss information stored in the storing apparatus.

10. The controlling apparatus according to claim 1,
wherein the controlling unit comprises a power target value determining unit that determines a target value of the output power of the power converting apparatus, based on a difference between the power value acquired by the acquiring unit and a power control target value, whenever the acquiring unit acquires the power value.

11. The controlling apparatus according to claim 10,
wherein the power value is a measured value of an active power and/or a measured value of a reactive power for the alternating-current power output by the power converting apparatus, and
the power target value determining unit executes at least one of determination of a target value of an output active power from the power converting apparatus and determination of a target value of an output reactive power from the power converting apparatus, the determination of the target value of the output active power being based on a difference between the measured value of the active power acquired by the acquiring unit and an active power control target value of the power, the determination of the target value of the output reactive power being based on a difference between the measured value of the reactive power acquired by the acquiring unit and a reactive power control target value of the power.

12. The controlling apparatus according to claim 10,
wherein the first grid includes a plurality of the first power generating apparatuses and a plurality of the power converting apparatuses,
a power line in which power lines to transmit alternating-current powers are joined to each other is connected with the second grid, the alternating-current powers being output by the power converting apparatuses, respectively, and
the power target value determining unit determines the target value of the output power for each of the power converting apparatuses.

13. The controlling apparatus according to claim 11,
wherein the first grid includes a plurality of power converting apparatuses,
a wattmeter measures, as the measured value of the active power, a sum of active powers for alternating-current powers output by the plurality of the power converting apparatuses, and
the power target value determining unit determines a target value of the sum of the active powers for the powers, based on a difference between the measured value of the active power and the active power control target value of the power, and determines the target values of the active powers to be output by the power converting apparatuses, based on the determined target value of the sum of the active powers for the powers.

14. The controlling apparatus according to claim 10,
wherein the acquiring unit sends the target value of the output power of the power converting apparatus determined by the power target value determining unit, to the corresponding power converting apparatus.

15. The controlling apparatus according to claim 1,
wherein the first grid is a local grid, and
the second grid is a power system.

16. A power converting apparatus comprising the controlling apparatus according to claim 1.

17. The power converting apparatus according to claim 16, further comprising:
a power converting unit that converts a direct-current power into an alternating-current power and outputs the converted alternating-current power to the second grid;
a measuring unit that measures a value of the alternating-current power output by the power converting unit; and
a conversion controlling unit that controls the power converting unit, based on the target value of the alternating-current power determined by the power target value determining unit and the value of the alternating-current power measured by the measuring unit.

18. The power converting apparatus according to claim 17,
wherein the measuring unit further measures an alternating current output by the power converting unit, and
the conversion controlling unit controls the power converting unit, further also based on the alternating current measured by the measuring unit.

19. The power converting apparatus according to claim 16,
wherein the dead band judging unit judges whether a combination of a measured value of an active power and a measured value of a reactive power is within a set range, the active power and the reactive power being supplied to one second grid of a plurality of second grids, the set range being previously set, and
the power converting apparatus comprises:
a power converting unit that converts a direct-current power into an alternating-current power and outputs the converted alternating-current power to the second grid;
a conversion controlling unit that controls the power converting unit such that the output power is altered, in a case where the dead band judging unit makes the judgment of being within the set range;
a measuring unit that measures an alteration amount of the output power; and
a communicating unit that sends the alteration amount measured by the measuring unit, to a different power converting apparatus, the different power converting apparatus controlling its own output power in the opposite direction to the alteration amount, by the same amount.

20. A controlling system controlling a power converting system in which power lines to transmit alternating-current powers output from a plurality of first grids are joined and are connected with a second grid, each of the first grids including a first power generating apparatus and a power converting apparatus that outputs an alternating-current power based on a power generated by the first power generating apparatus, the second grid including a second power generating apparatus,
wherein each of the first grids includes one or more power converting units that output the alternating-current power to the second grid, based on the power generated by the first power generating apparatus, and
the controlling system comprises:
a grid power target value determining unit that determines target values of reactive powers and/or target values of active powers such that a sum of the reactive powers and/or a sum of the active powers fall within predetermined ranges, the reactive powers and the active powers being output from the respective first grids; and
a plurality of controlling units that control an alternating-current power to be output by the power converting unit included in the corresponding first grid, based on the target values of the reactive powers and/or the target values of the active powers determined by the grid power target value determining unit.
